(19) United States
(12) Patent Application Publication
(10) Pub. No.: US 2026/0061703 A1
(43) Pub. Date: Mar. 5, 2026

(54) BUBBLE REMOVAL SYSTEMS AND METHODS FOR ADDITIVE MANUFACTURING

(71) Applicant: Align Technology, Inc., San Jose, CA (US)

(72) Inventors: Umesh Upendra Choudhary, Scotts Valley, CA (US); Parag Khimjibhai Shah, Fremont, CA (US); Viswanath Meenakshisundaram, Santa Clara, CA (US); Sonja Baumgartner, Vienna (AT); Thomas Förster-Romswinckel, Pixendorf (AT); Wolfgang Steiger, Vienna (AT); Daniel Glöcklhofer, Vienna (AT); Robert Gmeiner, Vienna (AT); Otmar Martl, Linz (AT)

(21) Appl. No.: 19/314,930

(22) Filed: Aug. 29, 2025

Related U.S. Application Data
(60) Provisional application No. 63/689,449, filed on Aug. 30, 2024.

(51) Int. Cl. B29C 64/314; B29C 64/245; B29K 105/00; B29L 31/00; B33Y 40/10

(52) U.S. Cl. CPC B29C 64/314; B29C 64/245; B33Y 40/10; B29K 2105/0094; B29L 2031/753

(57) ABSTRACT

Methods and systems for additive manufacturing are provided. In some embodiments, a method includes depositing a curable material on a substrate. The method can also include directing heat toward the curable material to remove one or more bubbles present in the curable material. The method can also include outputting energy toward the curable material on the substrate to form an object portion on a build platform according to an additive manufacturing process.

### CROSS-REFERENCE TO RELATED APPLICATION(S)

The present application claims the benefit of priority to U.S. Provisional Application No. 63/689,449, filed Aug. 30, 2024, the disclosure of which is incorporated by reference herein in its entirety.

### TECHNICAL FIELD

The present technology generally relates to manufacturing, and in particular, to systems and methods for removing bubbles during additive manufacturing.

### BACKGROUND

Additive manufacturing encompasses a wide variety of technologies that involve building up 3D objects from multiple layers of curable material. In some additive manufacturing systems, the curable material is supported by a transparent film or window, and energy is applied to the curable material through the film/window to selectively cure a portion of the curable material, thereby forming a portion of an object. In cases where the curable material is highly viscous, such as a resin, deposition of the curable material on the film/window can create bubbles of air or other gases within the curable material. These bubbles can persist in subsequent curing processes and be present in the final manufactured object. Unfortunately, these bubbles may provide stress concentration points that can cause premature, unpredictable object failure. For instance, an object with bubbles can be more likely to fracture, collapse, break, etc., at the location of the bubbles. Further, the bubbles can be a detriment to the object's aesthetics, which may be particularly acute in the case of transparent objects such as dental aligners.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic side view of a system for additive manufacturing configured in accordance with embodiments of the present technology.

FIGS. 2A-2C depict examples of additively manufactured objects including a plurality of bubbles.

FIGS. 3A-3D illustrate an example bubble formation process that can occur during an additive manufacturing process.

FIGS. 4A-4D illustrate an example additive manufacturing system in which bubbles may form.

FIGS. 5A-5C illustrate example physical phenomena that may affect bubbles in curable materials.

FIG. 6 is a partially schematic side view of a system for additive manufacturing configured in accordance with embodiments of the present technology.

FIG. 7 is a partially schematic side view of a portion of a system for additive manufacturing configured in accordance with embodiments of the present technology.

FIGS. 8A-8C illustrate various nozzle configurations suitable for use with the heating elements described herein, in accordance with embodiments of the present technology.

FIG. 9 is a partially schematic side view of a system for additive manufacturing configured in accordance with embodiments of the present technology.

FIG. 10 is a partially schematic side view of a system for additive manufacturing configured in accordance with embodiments of the present technology.

FIG. 11 is a flow diagram illustrating a method for bubble prevention and/or

removal during an additive manufacturing process, in accordance with embodiments of the present technology.

FIGS. 12A-12E illustrate representative examples of additive manufacturing systems with direct material feeding for bubble prevention, in accordance with embodiments of the present technology.

FIG. 13 is a partially schematic side view of a system for additive manufacturing configured in accordance with embodiments of the present technology.

FIG. 14 is a flow diagram illustrating a method for bubble prevention and/or removal during an additive manufacturing process, in accordance with embodiments of the present technology.

FIG. 15 is a partially schematic side view of a system for additive manufacturing configured in accordance with embodiments of the present technology.

FIG. 16 is a flow diagram illustrating a method for bubble prevention and/or removal during an additive manufacturing process, in accordance with embodiments of the present technology.

FIG. 17A illustrates a representative example of a tooth repositioning appliance configured in accordance with embodiments of the present technology.

FIG. 17B illustrates a tooth repositioning system including a plurality of appliances, in accordance with embodiments of the present technology.

FIG. 17C illustrates a method of orthodontic treatment using a plurality of appliances, in accordance with embodiments of the present technology.

FIG. 18 illustrates a method for designing an orthodontic appliance, in accordance with embodiments of the present technology.

FIG. 19 illustrates a method for digitally planning an orthodontic treatment and/or design or fabrication of an appliance, in accordance with embodiments of the present technology.

FIGS. 20A and 20B illustrate an additive manufacturing system with a heat gun for removing bubbles, in accordance with embodiments of the present technology.

FIGS. 21A and 21B are photographs illustrating a side view of printed object layers before (FIG. 21A) and after (FIG. 21B) application of hot air, in accordance with embodiments of the present technology.

FIGS. 22A-22C are photographs illustrating a deposition zone of an additive manufacturing system without (FIG. 22A) and with (FIGS. 22B and 22C) direct material feeding for bubble prevention, in accordance with embodiments of the present technology.

### DETAILED DESCRIPTION

The present technology relates to methods and systems for additive manufacturing. In some embodiments, for example, a system for manufacturing objects includes a material source configured to deposit a curable material (e.g., a resin) on a substrate (e.g., a carrier film). The system can also include one or more heating elements configured to heat at least a portion of the curable material to remove one or more bubbles present in the curable material. For instance, the heating can decrease the viscosity and/or surface tension of the curable material to cause the bubbles to rise to the surface of the curable material and burst, thereby removing the bubbles from the curable material. Additionally or alternatively, the heating can cause the bubbles to move toward higher-temperature portions of the curable material (e.g., via thermophoresis). The system can further include an energy source configured to output energy toward the curable material on the substrate to form an object portion according to an additive manufacturing process.

In some embodiments, a system for manufacturing objects includes a material source configured to deposit a curable material (e.g., a resin) on a carrier film. The system can also include an energy source configured to output energy toward the curable material on the substrate to form an object on a build platform according to an additive manufacturing process. The system may further include an actuator configured to cause movement of the carrier film relative to the build platform to separate the object portion from residual curable material on the carrier film, where the separation leaves a recess (e.g., an imprint corresponding to the separated object portion) in the residual curable material. The system may further include an elongated shaft (e.g., a wire) positioned against the carrier film, where the carrier film is movable relative to the elongated shaft to cause the residual curable material to be displaced from the carrier film and flow over the elongated shaft, thereby eliminating the recess. For instance, in some embodiments, the carrier film is configured to carry the residual curable material to a wire. The wire can contact the carrier film to temporarily scrape off the residual curable material from the carrier film. The residual curable material can coalesce while flowing over the wire, and subsequently be deposited back onto the carrier film, eliminating any recesses in the residual curable material on the carrier film.

In some embodiments, a system for manufacturing objects includes a material source configured to deposit a curable material (e.g., a resin) on a substrate (e.g., a carrier film). The system can further include an energy source configured to output energy toward the curable material on the substrate to form an object portion on a build platform according to an additive manufacturing process. The system can further include a solvent reservoir configured to cover residual curable material left on the substrate after the object portion has been separated from the substrate with a solvent (e.g., a solvent incompatible with the residual curable material), where the residual curable material includes a recess corresponding to the separated object portion. The system can also include a blade disposed in the solvent reservoir, the blade being configured to smooth out the residual curable material to remove the recess while the residual curable material is covered by the solvent. For instance, the solvent can temporarily fill in the recess to prevent air bubbles from forming within the recess, and the blade can smooth the residual curable material including the recess to remove the recess from the residual curable material.

The present technology can provide numerous advantages compared to conventional additive manufacturing methods and systems. In some embodiments, an object is fabricated from a viscous material, which may provide improved mechanical properties (e.g., stiffness, strength, stability) compared to other types of materials. However, some viscous materials may suffer from poor flowability and be more likely to trap air or other gases, forming bubbles in the material. As will be discussed further herein, the present technology includes systems and methods for removing bubbles from curable materials such as highly viscous materials, thereby improving their usability in additive manufacturing. Conventional techniques for removing bubbles typically rely on the application of chemicals to the material, which can be highly material-specific and require testing and optimization. Moreover, these chemical techniques may suffer from downstream compatibility issues. For instance, the applied chemicals may be toxic or otherwise not biocompatible, and thus may not be suitable for the manufacture of a medical device, such as a dental aligner to be worn by a patient. The methods and systems described herein can utilize physical processes and be applied to a variety of materials without needing extensive customization. Further, the systems and methods provided herein can improve material recycling by allowing a continuous flow of material with concurrent bubble removal, without needing to stop the printing process. This can further reduce material waste, by reducing the amount of material discarded due to the presence of bubbles.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Overview of Additive Manufacturing Technology

The systems, methods, and devices described herein are suitable for use with a wide variety of additive manufacturing techniques. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section IV below.

In some embodiments, additive manufacturing includes depositing a precursor material (e.g., a resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using vat photopolymerization process in which light is used to selectively cure a vat or other bulk source of a curable material (e.g., a polymerizable resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymerizable resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Additionally or alternatively, materials suitable for use with the systems and methods described herein can have a viscosity in the range of 0.05 Pa·s to 100 Pa·s at a temperature within a range from 20° C. to 160° C., 40° C. to 140° C., or 50° C. to 120° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built-up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built-up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

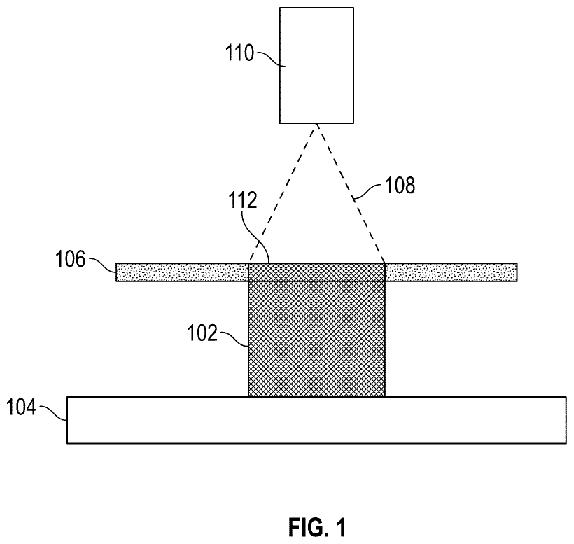

FIG. 1 is a partially schematic illustration providing a general overview of an additive manufacturing process, in accordance with embodiments of the present technology. In the illustrated embodiment, an object 102 is fabricated on a build platform 104 from a series of cured material layers, with each layer having a geometry corresponding to a respective cross-section of the object 102. To fabricate an individual object layer, a layer of curable material 106 (e.g., polymeric resin) is brought into contact with the build platform 104 (when fabricating the first layer of the object 102) or with the previously formed portion of the object 102 on the build platform 104 (when fabricating subsequent layers of the object 102). In some embodiments, the curable material 106 is formed on and supported by a substrate (not shown), such as a film. Energy 108 (e.g., light) from an energy source 110 (e.g., a laser, projector, or light engine) is then applied to the curable material 106 to form a cured material layer 112 on the build platform 104 or on the object 102. The remaining curable material 106 can then be moved away from the build platform 104 (e.g., by lowering the build platform 104, by moving the build platform 104 laterally, by raising the curable material 106, and/or by moving the curable material 106 laterally), thus leaving the cured material layer 112 in place on the build platform 104 and/or object 102. The fabrication process can then be repeated with a fresh layer of curable material 106 to build up the next layer of the object 102.

The illustrated embodiment shows a “top down” configuration in which the energy source 110 is positioned above and directs the energy 108 down toward the build platform 104, such that the object 102 is formed on the upper surface of the build platform 104. Accordingly, the build platform 104 can be incrementally lowered relative to the energy source 110 as successive layers of the object 102 are formed. In other embodiments, however, the additive manufacturing process of FIG. 1 can be performed using a “bottom up” configuration in which the energy source 110 is positioned below and directs the energy 108 up toward the build platform 104, such that the object 102 is formed on the lower surface of the build platform 104. Accordingly, the build platform 104 can be incrementally raised relative to the energy source 110 as successive layers of the object 102 are formed.

### II. Bubble Formation During Additive Manufacturing

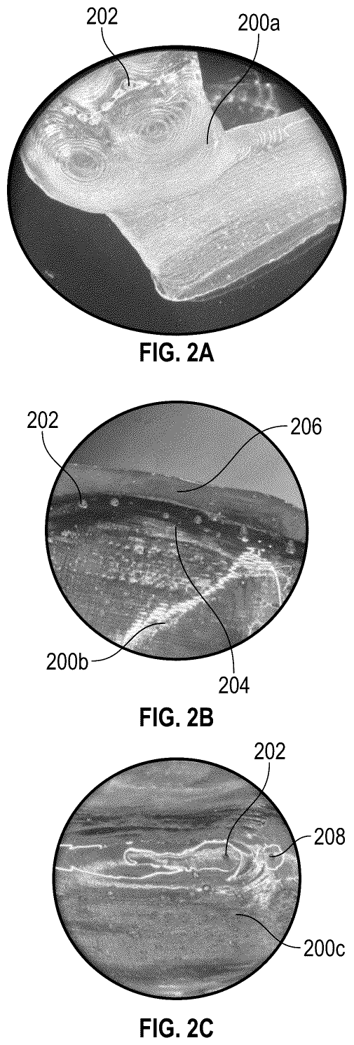

The presence of bubbles in an additively manufactured object can cause impaired object function, aesthetics, and/or quality. Bubbles can form during additive manufacturing, for instance, when viscous materials (e.g., high viscosity or low viscosity materials) such as resins are used. Bubble formation may occur when material is displaced and/or additional material is deposited on a substrate, e.g., during recoating processes. These bubbles can include air or other gases that are trapped in the material. Further, bubbles may already be present within the material itself, e.g., the material can be deposited with bubbles already formed therein. Bubbles may have varying sizes, such as from 25 μm up to 1 mm in diameter. Smaller bubbles may scatter light to provide an uneven and/or nontransparent appearance, while larger bubbles may create stress concentration locations that impair the mechanical properties of the object. Various bubble formation processes and dynamics will now be discussed with reference to FIGS. 2A-5C.

FIGS. 2A-2C depict examples of additively manufactured objects 200a-200c including a plurality of bubbles 202. Specifically, FIG. 2A is a perspective view of a first object 200a, FIG. 2B is a close-up view of a second object 200b, and FIG. 2C is a close-up view of a third object 200c. In some examples, the objects 200a-200c are dental appliances formed using an additive manufacturing technique, such as a dental aligner shaped to reposition one or more of a patient's teeth. However, it will be appreciated that the bubble formation processes described herein may occur in other types of additively manufactured objects besides dental appliances.

Referring to FIGS. 2A-2C collectively, the bubbles 202 can result from air or other gases being trapped in a curable material during an additive manufacturing process. The bubbles 202 can provide stress concentration points, which can lead to premature object failure and/or impaired object function. For instance, the objects 200a-200c may be more likely to deform (e.g., bend, fracture, split, break) at or near the bubbles 202. Further, the bubbles 202 can contribute to aesthetic issues, such as noticeable flaws, unwanted light scattering and/or reflections, etc. In some cases, the bubbles 202 can impact the surface finish (e.g., topography) of the objects 200a-200c. For instance, as depicted in FIG. 2B, one or more indentations 204 can be formed near an object edge 206 of the second object 200b. The indentations 204 can correspond to an unintended geometrical change caused by the bubbles 202, e.g., via material compression and/or displacement from the bubbles 202. Further, as depicted in FIG. 2C, one or more bumps 208 can be formed in the third object 200c as a result of the bubbles 202, e.g., via material expansion and/or displacement from the bubbles 202.

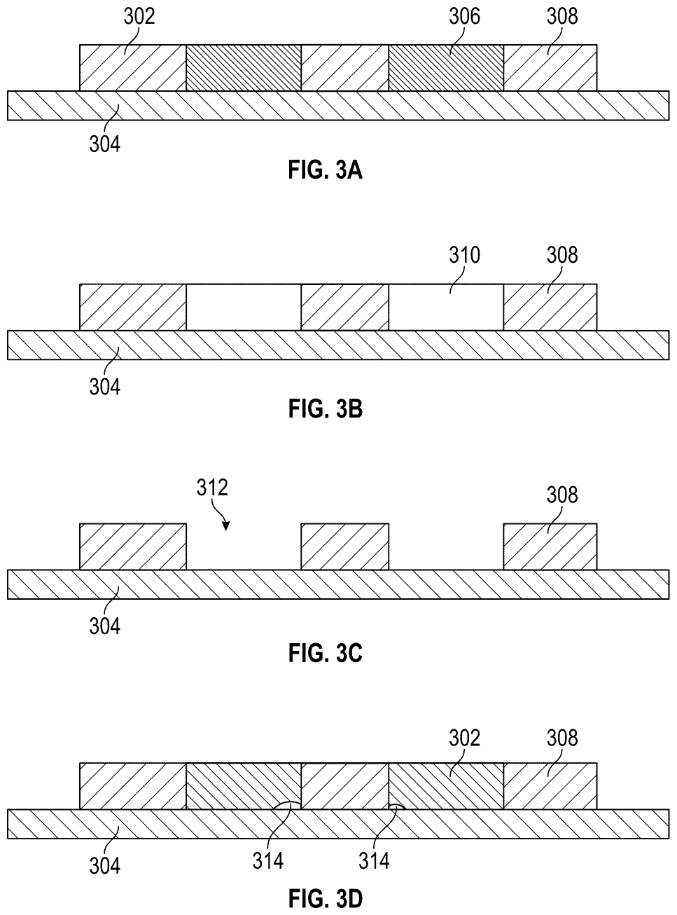

FIGS. 3A-3D illustrate an example bubble formation process that can occur during an additive manufacturing process. Specifically, FIG. 3A illustrates curing of a layer of curable material during the additive manufacturing process, FIG. 3B illustrates the layer of curable material with cured object portions, FIG. 3C illustrates removal of the cured object portions from the layer of curable material, and FIG. 3D illustrates deposition of additional curable material onto the layer of curable material.

In some examples, the additive manufacturing process includes the sequential deposition and curing of a material 302 on a substrate 304 to form an object in a layer-by-layer manner. Referring first to FIG. 3A, a layer of material 302 can be deposited on the substrate 304, and energy can be applied to target portions 306 of the material 302 and not to remaining portions 308, resulting in curing of the target portion 306 while the remaining portions 308 are uncured. The curing of the target portions 306 can produce an object portion 310 (e.g., an object layer), as depicted in FIG. 3B. The object portion 310 can then be separated from the remaining portions 308 (also known as uncured portions 308) and the substrate 304. Following the separation of the object portion 310, a recess 312 (e.g., an imprint) corresponding to the object portion 310 may be left behind, as depicted in FIG. 3C. To form the next object portion (e.g., next object layer), the additive manufacturing process may further include depositing additional material 302 on the substrate 304 to fill the recess 312. As depicted in FIG. 3D, the filling of the recess 312 can result in the formation of one or more bubbles 314. The bubbles 314 can include air or other gases that become trapped as the additional material 302 is deposited into the recesses 312, e.g., if the material 302 is too viscous to allow the bubbles 314 to rise to the surface of the material 302 and burst. The bubbles 314 can be present in the subsequent portions of the manufactured object, for instance, as a result of curing the additional material 302 without first removing the bubbles 314.

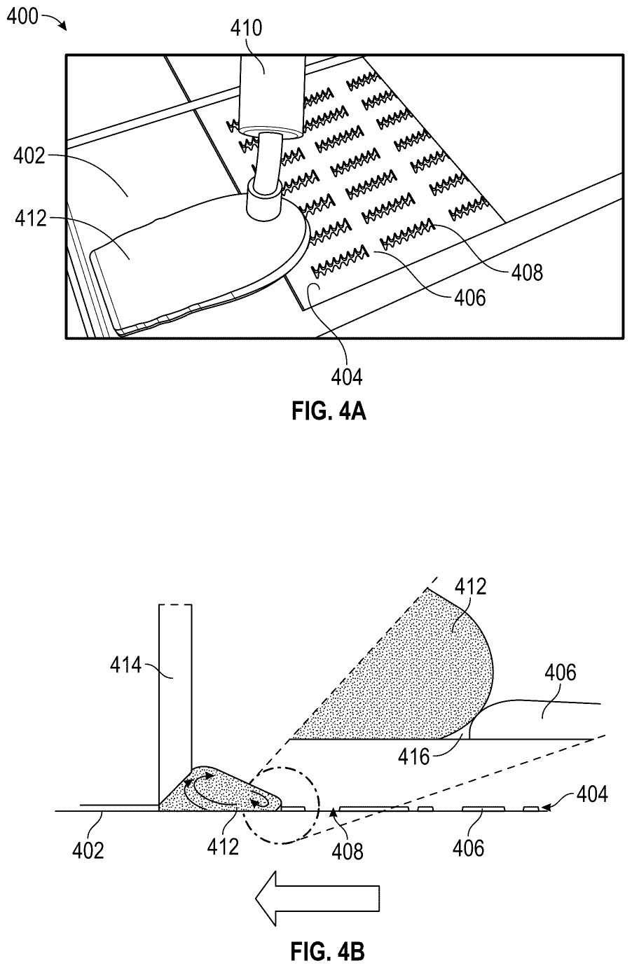

FIGS. 4A-4D illustrate an example additive manufacturing system in which bubbles may form. Specifically, FIG. 4A is a perspective view of a portion of an additive manufacturing system 400, FIG. 4B is a partially schematic side view of the system 400, FIG. 4C is another perspective view of the system 400, and FIG. 4D is another partially schematic side view of the system 400.

Referring first to FIG. 4A, the additive manufacturing system 400 can include a substrate 402 (e.g., a carrier film) having a material layer 404 deposited thereon. In the illustrated example, the material layer 404 is depicted following the removal (e.g., separation) of cured object portions from the material layer 404 and the substrate 402. Accordingly, the material layer 404 can include uncured material 406 and one or more recesses 408. The recesses 408 can correspond to the removed cured object portions. A material source 410 can be configured to deposit additional material 412 on the substrate 402 to fill the recesses 408. The additional material 412 can be the same material as used in the material layer 404. In some cases, as the material source 410 deposits the additional material 412, air or other gases can be trapped under the additional material 412 and/or within the recesses 408, thereby forming bubbles.

The additive manufacturing system 400 can also include a blade 414 (depicted in FIG. 4B) configured to smooth the additional material 412 over the material layer 404 onto the substrate 402 to a desired uniform thickness. The blade 414 can be positioned downstream of the material source 410. The presence of the blade 414 can cause the additional material 412 to build up behind the blade 414, and the built-up material 412 can also trap air or other gases within the material layer 404 to form bubbles 416, particularly at the locations of the recesses 408. These bubbles 416 can be present in the manufactured object following curing of the material layer 404. In some cases, this problem may be amplified in subsequent processes during additive manufacturing, such that the bubbles 416 are present in a plurality of material layers 404.

Alternatively or in combination, the bubbles 416 may already be present in the material 412 prior to and/or during deposition of the material 412 onto the substrate 402. Referring now to FIG. 4C, the composition of the material 412 in the material source 410 may include trapped gases due to pressure differences between the material source 410 and the environment. In some examples, the material source 410 can be connected to the environment via a nozzle 418. Pressure differences between the material source 410, nozzle 418, and/or the environment can cause incorporated gases (e.g., air), as well as dissolved gases (e.g., dissolved oxygen) to form bubbles in the material source 410. This can be due to, for example, pressure-driven compression and/or expansion and/or movement of the gases. In some instances, degassing of the material 412 is challenging or not possible, e.g., oxygen-based inhibition may be beneficial for controlling the curing depth.

Alternatively or in combination, the bubbles 416 may be introduced into the material 412 during deposition. For instance, deposition of the material 412 from the material source 410 toward the substrate 402 may include turbulent flow of the material 412 inside the material source 410, nozzle 418, and/or outlets thereof. The turbulent flow may increase the pressure differences between the material source 410, nozzle 418, and/or the environment; increase the exposure of the material 412 to the environment; and/or cause the material 412 to collide with itself, trapping air and causing bubbles to form.

Further, in some examples, bubbles may form due to the material 412 being deposited in a discontinuous manner. Referring now to FIG. 4D, the material 412 can, for example, be deposited discontinuously as discrete droplets that traverse an air gap before falling onto the surface of the material layer 404. The discontinuous deposition may cause air or other gases to be trapped in between droplets and/or in between the droplets and the material layer 404, thereby forming bubbles 416. Additionally, in embodiments where there is a temperature difference between the material source 410, environment, and/or material layer 404 (e.g., the material source may be at a lower temperature T₁ and the material layer 404 may be at a higher temperature T₂), this temperature difference may cause the material 412 to be more prone to bubble formation, as will be discussed further herein.

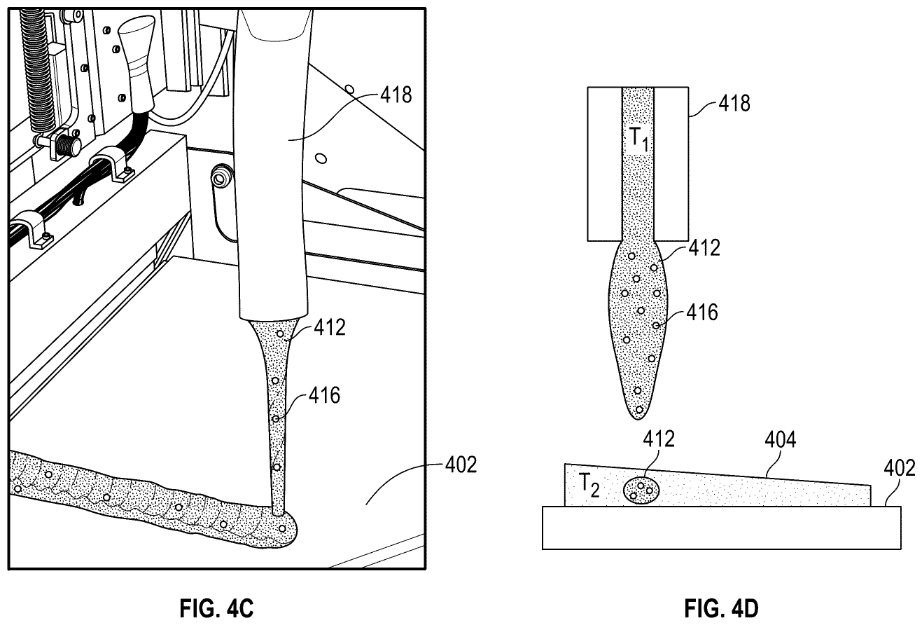

FIGS. 5A-5C illustrate example physical phenomena that may affect bubbles in curable materials. Specifically, FIG. 5A is a schematic illustration of forces acting on a bubble 502, FIG. 5B is a schematic illustration of a material 504 including one or more bubbles 502 trapped therein, and FIG. 5C is another schematic illustration of the material 504 including one or more bubbles 502 trapped therein. The material 504 can be a curable material, e.g., a curable resin.

Referring first to FIG. 5A, without wishing to be bound by theory, it is hypothesized that the behavior of the bubble 502 in the material 504 may be influenced by the drag force F_{D}, buoyant force F_{B}, and gravity g acting on the bubble 502. For a spherical object with a low Reynolds number (Re) in a viscous fluid (e.g., the material 504), the drag force (F_{D}) can be calculated from the object diameter (D), dynamic viscosity of the fluid (μ), and relative velocity to the fluid (v) by Stoke's law:

F_{D}=3πμDv

Accordingly, a spherical object's drag force F_{D} in a fluid can increase with the object's diameter and/or dynamic viscosity of the fluid. At the same time, the spherical object's buoyant force F_{B} (e.g., buoyancy) is proportional to its volume, in that larger bubbles are more buoyant. Moreover, a gravitational force g can also affect the spherical object, in that larger bubbles are susceptible to larger gravitational forces. These forces, combined, can be used to model aspects of vertical movement (e.g., translation) of the bubble 502 in the material 504.

Further, without wishing to be bound by theory, it is hypothesized that the behavior of the bubble 502 in the material 504 may additionally or alternatively be influenced by migration forces resulting from the effect of thermophoresis (F_{T}) (referred to herein as “thermophoresis forces”). Thermophoresis forces can cause bubbles in fluids to move toward material portions with higher temperature, e.g., due to lower surface tension and/or lower pressure in higher-temperature portions compared to lower-temperature portions. In the example of FIG. 5A, a temperature gradient 516 is present in the material 504, with a first portion 512 being at a higher temperature T₂ and a second portion 514 being at a lower temperature T₁ (T₂−T₁>0), thus resulting in a thermophoresis force F_{T} causing the bubble 502 to migrate away from the cooler second portion 514 toward the hotter first portion 512. The temperature gradient and thermophoresis force F_{T} shown in FIG. 5A can be generated in various ways, e.g., by heating the first portion 512 only, cooling the second portion 514 only, or by both heating the first portion 512 and cooling the second portion 514.

Turning now to FIG. 5B, in some examples, the bubbles 502 can include both small bubbles 506 and large bubbles 508. The large bubbles 508 have a larger volume than the small bubbles 506, and therefore have a higher buoyant force F_{B}, and thus may generally rise to the surface 510 of the material 504 and burst faster than the small bubbles 506. However, the drag force F_{D} on the bubbles increases as the diameter of the bubble 502 increases. If the buoyant force F_{B} of a bubble 502 is sufficient to overcome the drag force F_{D} and any gravitational forces g, then the bubble 502 will rise. However, if the buoyant force F_{B} of the bubble 502 is insufficient to overcome the drag force F_{D} and any gravitational forces g, the bubble 502 may remain in its current location or sink further into the material 504. In addition, the bubble 502 may rise at a slower rate if the viscosity of the material is higher due to a larger drag force F_{D}. Conversely, the bubble 502 may rise at a faster rate if the viscosity of the material is lowered.

Turning now to FIG. 5C, the movement of the bubble 502 can also be affected by the layer height H of the material 504. When the layer height H is relatively small, the bubble 502 has a smaller distance to traverse to rise to the surface 510 of the material 504 and burst. This can correspond to a decrease in time-to-surface for the bubble 502. Moreover, once the bubble 502 reaches and contacts the surface 510 of the material 504 (see bubble 502a, for example), the film of the bubble 502 becomes thinner and is more likely to burst due to a decreasing surface tension. Accordingly, it may take a shorter amount of time for the bubble 502 to rise and burst when the bubble 502 is closer to the surface 510 than when the bubble 502 is further from the surface 510. Further, it may take a shorter amount of time for larger bubbles (e.g., large bubbles 508) to rise and burst than smaller bubbles (e.g., small bubbles 506) due to their proximity to the surface 510, provided the same layer height H.

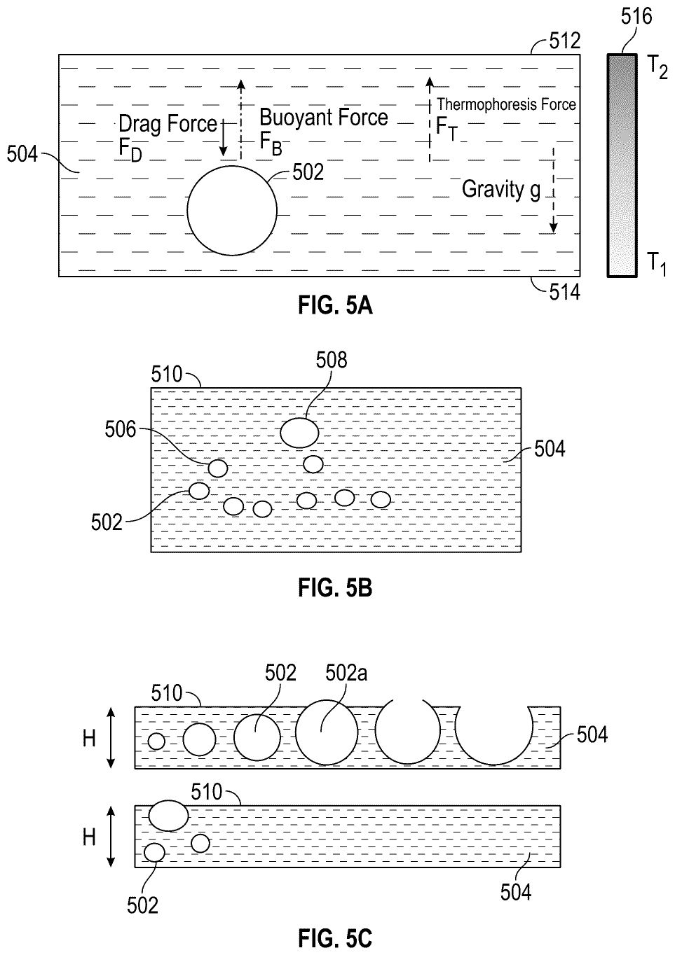

As further described herein, modifying the properties of the material 504 can improve the removal of the bubbles 502, e.g., increase the rate at which the bubbles 502 move to the surface 510 of the material 504 and burst. For instance, increasing the temperature of the material 504 (e.g., with a heating element, as discussed below with respect to FIGS. 6-11) can decrease the viscosity and/or surface tension of the material 504. The decrease in the surface tension of the material 504 can cause the volume of the bubbles 502 to increase, as governed by:

$$p = \frac{4 σ}{r}$$

where p is pressure, σ is surface tension, and r is bubble radius.

Heating of the material 504 can also increase the volume of the bubbles 502 based on the ideal gas law:

$$pV = nRT$$

where p is pressure, V is volume, n is the number of moles of gas, R is the gas constant, and T is temperature. Applied to the bubbles 502, as the temperature of the bubbles 502 increases while the surface tension decreases (and thereby pressure decreases), the volume of the bubbles 502 will increase. As the volume of the bubbles 502 increases, the buoyant force F_{B} of the bubbles 502 increases and the bubbles 502 will be more likely to escape the material 504.
III. Systems and Methods for Removing and/or Preventing Bubbles

In some embodiments, the systems and methods described herein utilize heating to facilitate bubble removal. As previously described in connection with FIGS. 5A-5C, heating a material during an additive manufacturing process can increase the likelihood that bubbles in the material rise to the surface and burst, and/or move to higher-temperature portions of the material. For instance, a heated material may have decreased viscosity and/or surface tension, as well as increased bubble volume and/or motility compared to its unheated state. Various heating methods and arrangements will now be described with reference to FIGS. 6-11.

FIG. 6 is a partially schematic side view of a system 600 for additive manufacturing configured in accordance with embodiments of the present technology. The system 600 is configured to fabricate one or more objects 604 using an additive manufacturing process (a single object 604 is shown in FIG. 6 merely for purposes of simplicity). In some embodiments, the system 600 is configured to apply heating during the additive manufacturing process to reduce or prevent bubbles in the objects 604. Optionally, the system 600 may be additionally or alternatively be configured to apply cooling during the additive manufacturing process to prevent bubble formation, as discussed further herein.

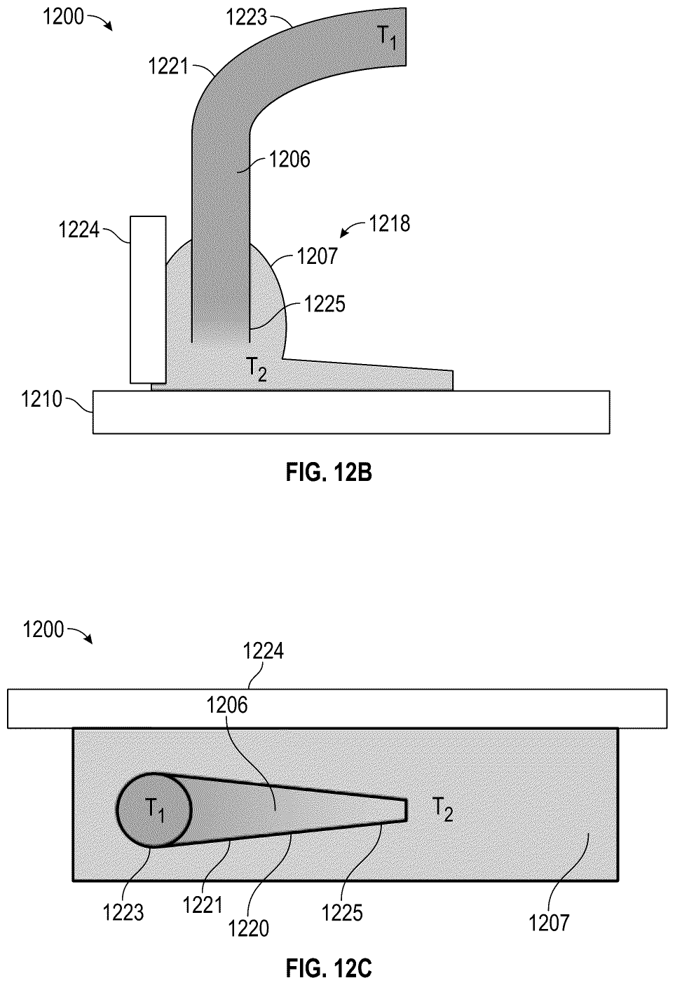

The system 600 includes a printer assembly 602 that forms the object 604 on a build platform 608 (e.g., a tray, plate, film, sheet, printer bed, or other planar or non-planar substrate) by applying energy to a curable material 606 (e.g., a photopolymerizable resin). In the illustrated embodiment, the printer assembly 602 includes a carrier film 610 configured to deliver the curable material 606 to the build platform 608. The carrier film 610 can be a flexible loop of material having an outer surface and an inner surface. The outer surface of the carrier film 610 can adhere to and carry a thin layer of the curable material 606. The inner surface of the carrier film 610 can contact one or more rollers 612a-612f that rotate to move the carrier film 610 in a continuous loop trajectory, e.g., along the directions indicated by arrows 614. The rollers 612a-612f can include any suitable geometry for facilitating the movement of the carrier film 610. For instance, the rollers 612a-612f can include cylinders, spools, blades, etc. The printer assembly 602 can also include a material source 616 configured to apply the curable material 606 to the carrier film 610 at a deposition zone 618 (also known as a “coating zone” or “recoating zone”). In the illustrated embodiment, the material source 616 is located at the upper portion of the printer assembly 602, and the deposition zone 618 is an upper horizontal segment of the carrier film 610 between rollers 612a and 612f. In other embodiments, however, the material source 616 and/or deposition zone 618 can be at different locations in the printer assembly 602. The material source 616 can include nozzles, ports, reservoirs, etc., that deposit the curable material 606 onto the outer surface of the carrier film 610. In some embodiments, for instance, the material source 616 includes a nozzle 620 coupled to a reservoir 622. The outlet of the nozzle 620 may be positioned above the curable material 606 at the deposition zone 618 or may be positioned in direct contact with the curable material 606 at the deposition zone 618, e.g., as discussed further below with respect to FIGS. 12A-12E. The system 600 can also include one or more blades 624 (e.g., doctor blades, recoater blades) that smooth the deposited curable material 606 into a relatively thin, uniform layer. For example, the curable material 606 can be formed into a layer having a thickness within a range from 75 microns to 500 microns, 200 microns to 600 microns, or any other desired thickness. In some embodiments, the layer thickness of the curable material 606 varies during fabrication of the one or more objects 604, such that different layers of the objects 604 may have different thicknesses. For instance, the system 600 can be configured to fabricate a first layer of the one or more objects 604 using a layer thickness of 100 microns of the curable material 606 and a second layer of the one or more objects 604 using a layer thickness of 200 microns of the curable material 606.

In some embodiments, the curable material 606 is deposited continuously. For instance, rather than depositing the curable material 606 incrementally, e.g., every N layers, the curable material 606 can be deposited continuously throughout fabrication of the one or more objects 604. This may include depositing the curable material 606 at a lower flow rate overall, as opposed to depositing the curable material 606 at a higher flow rate intermittently, which may inadvertently increase the likelihood of bubble formation. In some embodiments, the curable material 606 can be deposited continuously at a flow rate within a range from 0.1 mL per minute to 200 mL per minute, such as 0.1 mL per minute, 0.5 mL per minute, 1 mL per minute, 5 mL per minute, 10 mL per minute, 20 mL per minute, 50 mL per minute, 100 mL per minute, 150 mL per minute, or 200 mL per minute. Further, the flow rate at which the curable material 606 is deposited may be constant or may change over time. For instance, particular layers of the object 604 may be associated with changes in the flow rate of material deposition (e.g., increasing rate, decreasing rate). Alternatively or in combination, the flow rate of material deposition and/or the amount of material deposited may change every N layers, where N is 1, 2, 3, 4, 5, 10, 20, 30, 50, 100, 200, etc.

The curable material 606 can be conveyed by the carrier film 610 toward the build platform 608. In some embodiments, the curable material 606 is transported through a pre-print zone 626 downstream of the deposition zone 618. The pre-print zone 626 can include a vertical segment, an angled segment, or a combination thereof of the carrier film 610. For instance, although the pre-print zone 626 is illustrated as having a vertical segment of the carrier film 610 between the rollers 612a and 612b and an angled segment of the carrier film 610 between the rollers 612b and 612c, in other embodiments, the pre-print zone 626 can include only a vertical segment or only an angled segment.

The build platform 608 can be located proximate to a print zone 628 of the carrier film 610. In the illustrated embodiment, the build platform 608 is located below the printer assembly 602, and the print zone 628 is a lower horizontal segment of the carrier film 610 between rollers 612c and 612d. In other embodiments, however, the build platform 608 and/or print zone 628 can be positioned at different locations in the printer assembly 602. The distance between the carrier film 610 and build platform 608 can be adjustable so that the curable material 606 at the print zone 628 can be brought into direct contact with the surface of the build platform 608 (when printing the initial layer of the object 604) or with the surface of the object 604 (when printing subsequent layers of the object 604). For example, the build platform 608 can include or be coupled to an actuator (e.g., a motor—not shown) that raises and/or lowers the build platform 608 to the desired height during the manufacturing process. Alternatively or in combination, the printer assembly 602 can include or be coupled to a motor (not shown) that raises and/or lowers the printer assembly 602 relative to the build platform 608.

The printer assembly 602 can include an energy source 630 (e.g., a projector, light engine, and/or laser-scanner) that outputs energy 632 (e.g., light, such as UV light) having a wavelength configured to partially or fully cure the curable material 606. The carrier film 610 can be partially or completely transparent to the wavelength of the energy 632 to allow the energy 632 to pass through the carrier film 610 and onto the portion of the curable material 606 above the build platform 608. Optionally, a transparent plate 634 can be disposed between the energy source 630 and the carrier film 610 to guide the carrier film 610 into a specific position (e.g., height) relative to the build platform 608. During operation, the energy 632 can be patterned or scanned in a suitable pattern onto the curable material 606, thus forming a layer of cured material 636 onto the build platform 608 and/or on a previously formed portion of the object 604. The geometry of the cured material 636 can correspond to the desired cross-sectional geometry for the object 604. The parameters for operating the energy source 630 (e.g., exposure time, exposure pattern, exposure wavelength, energy density, power density) can be set based on instructions from a controller 638, as described in further detail below.

In some embodiments, the energy 632 is applied to the curable material 606 while the carrier film 610 moves to circulate the curable material 606 through the print zone 628. To maintain zero or substantially zero relative velocity between the curable material 606 and the build platform 608, the printer assembly 602 can concurrently move horizontally relative to the build platform 608 opposite the direction of the motion of the carrier film 610 at the print zone 628. The motion of the printer assembly 602 can also increase the printable surface area of the build platform 608. The energy 632 output by the energy source 630 can be coordinated with the movement of the carrier film 610 and build platform 608 so that the layer of cured material 636 is formed with the correct geometry. For example, the energy source 630 can be a scrolling light engine (e.g., a scrolling DLP) or laser scanner that outputs the energy 632 in a pattern that varies over time to match the motion of the printer assembly 602 and carrier film 610. In other embodiments, however, the printer assembly 602 can be a stationary device that does not move relative to the build platform 608 while the energy 632 is being applied to the curable material 606.

After curing, the newly formed layer of cured material 636 can be separated from the carrier film 610 and the remaining curable material 606 at the print zone 628. In some embodiments, the separation occurs at least in part due to peel forces produced by the carrier film 610 wrapping around the roller 612d immediately downstream of the print zone 628. The remaining curable material 606 can be conveyed by the carrier film 610 away from the build platform 608, and into a post-print zone 640 downstream of the print zone 628. As described elsewhere herein, the remaining curable material 606 can include recesses 642 left by separation of the cured material 636 from the carrier film 610. The post-print zone 640 can include a vertical segment, an angled segment, or a combination thereof of the carrier film 610. For instance, although the post-print zone 640 is illustrated as having an angled segment of the carrier film 610 between the rollers 612d and 612e and a vertical segment of the carrier film 610 between the rollers 612e and 612f, in other embodiments, the system 600 can include only a vertical segment or only an angled segment. The presence of an angled segment of carrier film 610 immediately downstream of the print zone 628 can adjust the peel angle produced by the roller 612d, and thus, the peel force applied to the cured material 636, to enhance separation from the surrounding curable material 606.

The remaining curable material 606 conveyed away from the build platform 608 can be circulated by the carrier film 610 back toward the deposition zone 618. At the deposition zone 618, the material source 616 can apply additional curable material 606 onto the carrier film 610 and/or smooth the curable material 606 to fill in the recesses 642 and re-form a uniform layer of curable material 606 on the carrier film 610. The curable material 606 can then be recirculated back through the pre-print zone 626, and then to the print zone 628 and build platform 608 to fabricate subsequent layers of the object 604. This process can be repeated to iteratively build up individual object layers on the build platform 608 until the object 604 is complete. The object 604 and build platform 608 can then be removed from the system 600 for post-processing.

Optionally, the printer assembly 602 can be configured to produce the object 604 via a high temperature lithography process utilizing a highly viscous resin. In such embodiments, the printer assembly 602 can include one or more heat sources (heating plates, infrared lamps, etc.—not shown) for heating the curable material 606 to lower the viscosity to a range suitable for additive manufacturing. The heat sources can be positioned near or in direct contact with the carrier film 610 to heat the curable material 606 supported by the carrier film 610. For example, the printer assembly 602 can include a first heat source 644a positioned against the segment of the carrier film 610 before the build platform 608, and a second heat source 644b positioned against the segment of the carrier film 610 after the build platform 608. In some embodiments, the heat sources can additionally or alternatively be located at any suitable portion of the printer assembly 602, such as on or within the build platform 608, on or within the material source 616, at the deposition zone 618, on or within the coating blades 624, at the pre-print zone 626, at the print zone 628, at the post-print zone 640, or combinations thereof.

The system 600 can further include one or more heating elements 646a-646c (collectively, “heating elements 646”—shown schematically) positioned at one or more locations proximate to the printer assembly 602 for increasing a temperature of the curable material 606 to remove one or more bubbles present in the curable material 606. Bubbles may form, for example, during deposition of the material 606 from the material source 616 to fill the recesses 642, during smoothing of the deposited material 606 on the carrier film 610, and/or during exposure of the material 606 within the material source 616 to the environment, e.g., as described above with respect to FIGS. 2A-5C. The heating elements 646 can be configured to heat the curable material 606 to an increased temperature that promotes bubble removal, e.g., by modifying one or more properties of the curable material 606. Heating the curable material 606 can include heating the entirety of the curable material 606 or heating only a portion of the curable material 606, such as only a surface of the curable material 606. In some embodiments, heating the curable material 606 can decrease a viscosity of the curable material 606. Decreasing the viscosity of the curable material 606 can allow bubbles to surface and/or escape the curable material 606, as discussed above in connection with FIGS. 5A-5C. Alternatively or in combination, the output heat can decrease a surface tension of the curable material 606. Alternatively or in combination, the output heat can generate a temperature gradient in the curable material, leading to movement of bubbles toward higher-temperature portions of the curable material. The output heat may additionally or otherwise increase a motility of bubbles present in the curable material 606.

In some embodiments, the heating elements 646 are configured to heat at least a portion of the curable material 606 to a temperature of at least 40° C., 50° C., 60° C., 70° C., 80° C., 90° C., 100° C., 120° C., 150° C., 200° C., etc. Alternatively or in combination, the heating elements 646 can heat the curable material 606 to a temperature less than or equal to 200° C., 150° C., 120° C., 100° C., 90° C., 80° C., 70° C., 60° C., 50° C., 40° C., etc. Optionally, the heating elements can heat the curable material 606 to a temperature within a range from 40° C. to 120° C., 120° C. to 180° C., or 180° C. to 240° C.

In embodiments where the curable material 606 is heated for additive manufacturing (e.g., via a high temperature lithography process), the temperature for bubble removal may be higher than the temperature for additive manufacturing. For instance, the curable material 606 may be heated to a first temperature in the deposition zone 618 and/or the pre-print zone 626 for removing the bubbles and to a second temperature in the pre-print zone 626 and/or the print zone 628 before and/or during curing of the object 604. In some embodiments, the first temperature can be greater than the second temperature. For instance, the first temperature can be at least 10° C., 20° C., 30° C., 40° C., 50° C., 60° C., 70° C., etc. greater than the second temperature. In some embodiments, the curable material 606 may be allowed to cool down from the first temperature to the second temperature before curing of the curable material 606.

Various types of heating elements 646 can be used. For example, the heating elements 646 can include one or more heat guns, heated air knives, heating plates, infrared lamps, laser emitters, resistive heaters, etc. In some embodiments, the heating elements 646 include a heat gun, heated air knife, or similar device that heats the curable material 606 via forced convection, e.g., by outputting a stream of heated fluid toward the curable material 606. The heated fluid can include a heated gas, such as heated air. The heated fluid can decrease the surface tension of the curable material 606 and promote bubble motility and/or bursting in the curable material 606. In such embodiments, the heating elements 646 can be configured to output heat at a flow rate of 1-50 m/s, 3-40 m/s, or 4-35 m/s. Alternatively or in combination, the heating elements 646 can include a heating plate or similar device that heats the curable material 606 via thermal conduction, e.g., by directly contacting the curable material 606 to transfer heat from the heating plate to the curable material 606. Alternatively or in combination, the heating elements 646 can include a heat lamp or similar device that heats the curable material 606 via thermal radiation, e.g., by emitting infrared radiation toward the curable material 606. Further, the heating elements 646 can additionally or alternatively include other energy transfer techniques, such as applying optical energy to the curable material 606 to heat the curable material 606. For instance, the heating elements 646 can include a laser configured to output electromagnetic radiation (e.g., via photons) toward the curable material 606 to heat the curable material 606.

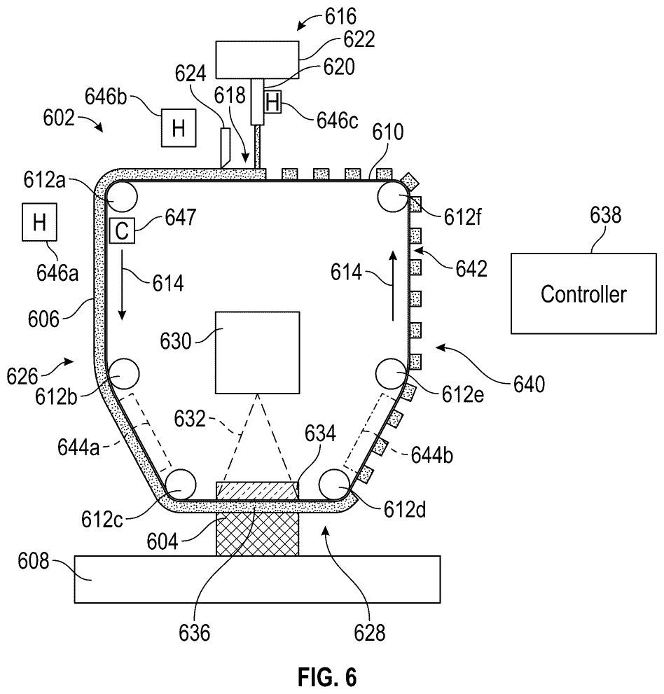

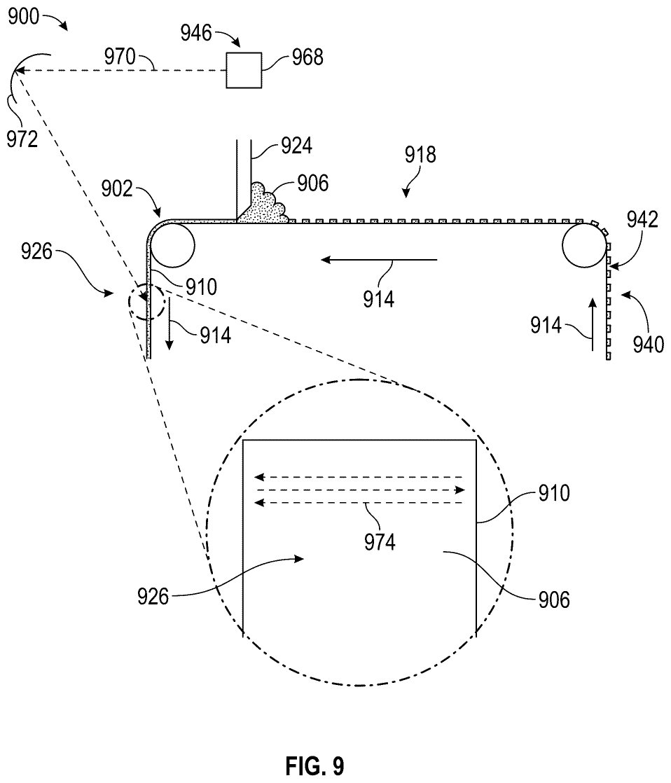

The heating elements 646 can be positioned at a variety of different locations relative to the printer assembly 602. For instance, in the illustrated embodiment, a first heating element 646a is positioned proximate to the pre-print zone 626. The first heating element 646a can be positioned proximate to a vertical segment (e.g., between the rollers 612a and 612b) of the pre-print zone 626. Alternatively or in combination, the first heating element 646a can be positioned proximate to an angled segment (e.g., between the rollers 612b and the 612c) of the pre-print zone 626. The first heating element 646a can be configured to increase a temperature of the curable material 606 following deposition of the curable material 606 on the carrier film 610 and before curing of the curable material 606 by the energy source 630. The first heating element 646a can be a heat gun, heated air knife, or similar device that directs a stream of heated fluid toward the curable material 606 in the pre-print zone 626, e.g., as discussed further below with respect to FIG. 7. Alternatively, the first heating element 646a can be a laser that directs a laser beam onto the curable material 606 in the pre-print zone 626, e.g., as discussed further below with respect to FIG. 9.

Additionally or alternatively, a second heating element 646b can be positioned downstream of the material source 616 and/or the blade 624, such as at a location proximate to the deposition zone 618. The second heating element 646b can be configured to increase a temperature of the curable material 606 following deposition of the curable material 606 on the carrier film 610 and before curing of the curable material 606 by the energy source 630. For instance, the second heating element 636b can be a heat gun, heated air knife, or similar device that directs a stream of heated fluid toward the curable material 606 in the deposition zone 618. Alternatively, the second heating element 636b can be a laser that directs a laser beam onto the curable material 606 in the deposition zone 618, e.g., as discussed further below with respect to FIG. 9.

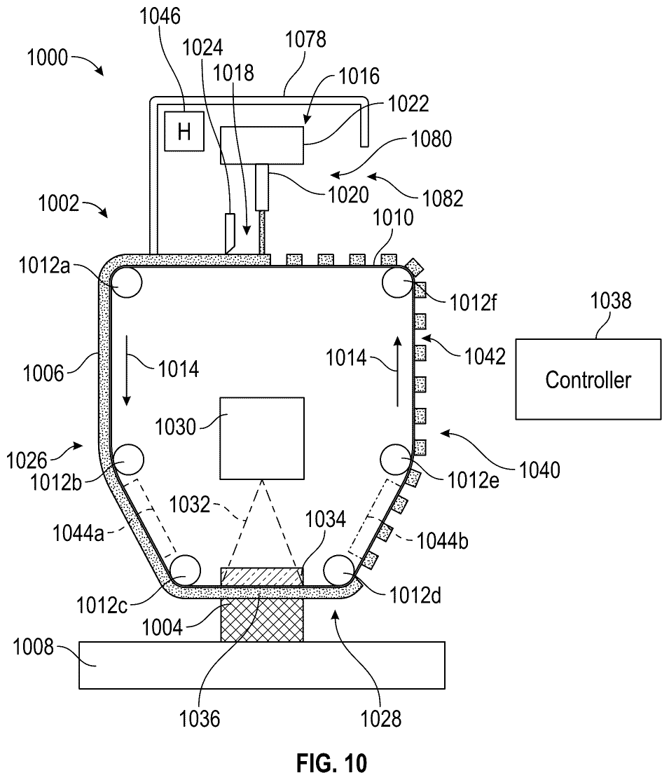

Alternatively or in combination, a third heating element 646c can be positioned proximate to the material source 616. The third heating element 646c can be a heating plate, heating rod, or similar device. For instance, the third heating element 646c can be a heating plate or other device that is mounted on the nozzle 620 of the material source 616, and can be configured to heat the curable material 606 while the curable material 606 passes through the nozzle 620. Alternatively or in combination, the third heating element 646c can be mounted above or adjacent to the reservoir 622 of the material source 616. For instance, the third heating element 646c can heat the reservoir 622 from a location external to the reservoir 622. Further, the third heating element 646c can alternatively or additionally be positioned within the material source 616. For example, the third heating element 646c can be positioned within the nozzle 620 and/or within the reservoir 622 of the material source 616. Moreover, the third heating element 646c may additionally or alternatively be coupled to a feed line of the material source 616, e.g., a feed line connecting the reservoir 622 to the nozzle 620. In some embodiments, the third heating element 646c may alternatively or additionally heat an environment of the material source 616. For instance, the third heating element 646c may be positioned within an enclosure (e.g., a cover) at least partially surrounding the material source 616 and/or deposition zone 618, and the third heating element 646c may be configured to heat the environment within the enclosure so that the curable material 606 within the material source 616 and/or deposition zone 618 is heated, e.g., as discussed further below with respect to FIG. 10.

Alternatively or in combination, a fourth heating element (not depicted) may be configured to heat the blade 624, such that the blade 624 is a heated blade. For example, the fourth heating element can be internal to the blade 624 and/or can be coupled to the exterior of the blade 624. In some embodiments, the heated blade 624 is configured to contact and heat the curable material 606 on the carrier film 610 at a location along a transport pathway between the deposition zone 618 and the pre-print zone 626. Optionally, a fifth heating element (e.g., a heating plate) or other heat source can be positioned against the carrier film at a location opposite of the heated blade 624. For instance, the heated blade 624 can be configured to heat the curable material 606 from above, and a heating plate can be configured to heat the curable material 606 from below (e.g., proximate to the carrier film 610). Although FIG. 6 depicts a single blade 624 in the deposition zone 618, there can be a plurality of blades 624 positioned in series along the deposition zone 618. For instance, the system 600 can include a heated blade and a non-heated blade. The heated blade may be configured to heat the curable material 606, while the non-heated blade may be positioned downstream of the heated blade to smooth the curable material 606 on the carrier film 610 (e.g., as discussed above in connection with the blade 414 of FIG. 4B). Further, in some embodiments, the blade 624 can be configured to be movable (e.g., translatable) relative to the printer assembly 602.

The first heating element 646a, second heating element 646b, and third heating element 646c are depicted and described above for illustrative purposes only. In other embodiments, the system 600 may include a different number of heating elements 646, such as one, two, four, five, or more heating elements 646. Some or all of the heating elements 646 may be the same type of heating element, or some or all of the heating elements 646 may be different types of heating elements. Moreover, the heating elements 646 may be positioned at different locations relative to the printer assembly, in addition or alternatively to the locations depicted in FIG. 6. In some embodiments, one or more heating elements 646 are located at the print zone 628 and/or at the post-print zone 640. For instance, the one or more heating elements 646 can be positioned proximate to an angled segment, e.g., between the rollers 612d and 612e, in the post-print zone 640. Optionally, the first heat source 644a and/or the second heat source 644b may be used as a heating element to remove bubbles from the curable material 606.

Optionally, the system 600 can further include one or more cooling elements 647 to cool at least a portion of the curable material 606 on the carrier film 610. Cooling the curable material 606 can include cooling the entirety of the curable material 606 or cooling only a portion of the curable material 606, such as only a surface of the curable material 606. The cooling elements 647 can be configured to create a temperature gradient within the curable material 606 to facilitate bubble removal, e.g., by promoting thermophoresis-induced migration of the bubbles to the surface of the curable material 606. Further, cooling the curable material 606 can increase the viscosity of the curable material 606, which may inhibit bubble formation in the curable material 606. In some embodiments, the cooling elements 647 are configured to cool at least a portion of the curable material 606 to a temperature of less than or equal to 200° C., 150° C., 120° C., 100° C., 90° C., 80° C., 70° C., 60° C., 50° C., 40° C., 30° C., 20° C., 10° C., etc.

In some embodiments, the cooling elements 647 can include a cool air gun, cold plate, thermoelectric cooler, cooling fin, ventilation unit, fan, etc. The cooling elements 647 can be positioned opposite of the heating elements 646. For instance, the heating elements 646 can be positioned closer to a material-supporting surface of the carrier film 610, and the cooling elements 647 can be positioned closer to a second surface opposite the material-supporting surface. In some embodiments, the cooling elements 647 can be positioned inside the printer assembly 602 and oriented toward the second surface of the carrier film 610. Optionally, the cooling element 647 can directly contact the carrier film 610.

The cooling element 647 is depicted and described above for illustrative purposes only. In some embodiments, the system 600 may include a different number of cooling elements 647, such as two, three, four, five, or more cooling elements 647. Some or all of the cooling elements 647 may be the same type of cooling element, or some or all of the cooling elements 647 may be different types of cooling elements. Moreover, the cooling elements 647 may be positioned at different locations relative to the printer assembly, in addition or alternatively to the location depicted in FIG. 6. For instance, one or more cooling elements 647 may be located after the deposition zone 602, at the pre-print zone 626, and/or at the post-print zone 640. For instance, the cooling elements 647 can be positioned proximate to an angled segment, e.g., between the rollers 612b and 612c in the pre-print zone 626 and/or between the rollers 612d and 612e of the post-print zone 640. Further, the cooling elements 647 may be used independently and/or separately from the heating elements 646. For instance, the cooling elements 647 can be used to create lower-temperature portions of the curable material 606, which may drive bubbles away from the lower-temperature portions and toward higher-temperature portions of the curable material 606.

The controller 638 (shown schematically) is operably coupled to the printer assembly 602 (e.g., to the build platform 608, rollers 612a-612f, material source 616, and/or energy source 630) and the heating element(s) 646 to control the operations thereof. The controller 638 can be or include a computing device including one or more processors and memory storing instructions for performing the additive manufacturing, error detection, and error correction operations described herein. For example, the controller 638 can receive a digital representation of the object 604 to be fabricated and can transmit instructions to the energy source 630 to apply energy 632 to the curable material 606 to form the object cross-sections. As previously discussed, the controller 638 can control various operational parameters of the energy source 630, such as the exposure time, exposure pattern, exposure wavelength, energy density, power density, and/or other parameters affecting the printing process. Optionally, the controller 638 can also determine and control other operational parameters, such as the positioning of the printer assembly 602 (e.g., vertical and/or horizontal position) relative to the build platform 608, the movement speed and/or direction of the carrier film 610, the rotational speed and/or direction of the rollers 612a-612f, the amount of curable material 606 deposited by the material source 616, the thickness of the curable material 606 on the carrier film 610, and/or the amount of heating applied to the curable material 606 by the heating element(s) 646.

FIGS. 7-10 illustrate representative examples of additive manufacturing systems with heating elements for bubble removal, in accordance with embodiments of the present technology. The systems of FIGS. 7-10 can be generally similar to the system 600 described above with respect to FIG. 6. Accordingly, like numbers (e.g., printer assembly 602 versus printer assembly 702) are used to identify similar or identical elements, and the discussion of the systems of FIGS. 7-10 will be limited to those features that are different from and/or that were not already discussed with respect to FIG. 6.

FIG. 7 is a partially schematic side view of a portion of a system 700 for additive manufacturing configured in accordance with embodiments of the present technology. The system 700 is configured to fabricate one or more objects using an additive manufacturing process. In some embodiments, the system 700 is configured to apply heat during the additive manufacturing process to reduce or prevent bubbles in the objects.

The system 700 includes a printer assembly 702 that forms an object on a build platform by applying energy to a curable material 706 (e.g., a photopolymerizable resin). In the illustrated embodiment, the printer assembly 702 includes a carrier film 710 configured to transport the curable material 706. For instance, the carrier film 710 can adhere to and carry a thin material layer of the curable material 706 in a continuous loop trajectory (e.g., along the directions indicated by arrows 714) through a deposition zone 718, pre-print zone 726, print zone (not depicted), and post-print zone 740.

In some embodiments, the curable material 706 is deposited on the carrier film 710 by a material source (not depicted) at the deposition zone 718. Alternatively, or in combination, the curable material 706 can be deposited on or into remaining curable material 706 on the carrier film 710. The remaining curable material 706 can include curable material 706 that is left on the carrier film 710 following curing and separation of one or more object portions, as discussed elsewhere herein. Accordingly, the remaining curable material 706 can include one or more recesses 742 corresponding to the separated object portion(s). As additional curable material 706 is deposited on and/or into the remaining curable material 706, one or more bubbles can form in the recesses 742. For instance, the additional curable material 706 can trap air or other gases in the recesses 742, e.g., as discussed above in connection with FIG. 4A.

In some embodiments, the system 700 further comprises a blade 724 positioned downstream of the material source. The blade 724 can be configured to smooth the curable material 706 over the remaining curable material 706. As discussed above in connection with FIG. 4B, the presence of the blade 724 can cause the curable material 706 to build up behind the blade 724, and the built-up material 706 can also trap air or other gases within the recesses 742.

The system 700 can further include a heating element 746a configured to facilitate bubble removal from the curable material 706. The heating element 746a can be configured to heat the curable material 706 to an increased temperature that promotes bubble removal, e.g., by modifying one or more properties of the curable material 706. As discussed elsewhere herein, the modified properties can include a decreased viscosity of the curable material 706, a decreased surface tension of the curable material 706, and/or an increased bubble motility within the curable material 706. The heating element 746a can be positioned proximate to the printer assembly 702 (e.g., downstream of the material source and blade 724) to direct energy (e.g., thermal energy) toward the curable material 706 to heat the curable material 706, such as adjacent to the pre-print zone 726. Alternatively or in combination, other locations can be used, such as upstream of the material source and blade 724 within the deposition zone 718 (e.g., heating element 746b), immediately downstream of the blade 724 (e.g., heating element 746c), and/or proximate to the transition between the deposition zone 718 and the pre-print zone 726 (e.g., heating element 746d position) Any of the features described herein with respect to heating element 746a can also be applicable to heating elements 746b-746d. In some embodiments, the carrier film 710 includes a first surface configured to support the curable material 706 and a second surface opposite the first surface, and the heating element 746a can be positioned closer to the first surface than the second surface.

In the illustrated embodiment, the heating element 746a is a heat gun, heated air knife, or similar device that is configured to output a stream of heated fluid toward the curable material 706 on the carrier film 710 (e.g., in the direction 748). The heated fluid can be a heated gas, such as heated air. In some embodiments, the heated fluid is delivered at a flow rate of 1-50 m/s, or 3-40 m/s, or 4-35 m/s. Optionally, the flow rate can be sufficiently high to apply pressure to the surface of the curable material 706 to facilitate bubble removal, e.g., by reducing the surface tension of the curable material 706 and/or by applying force to burst the bubbles.

In some embodiments, the heating element 746a outputs a stream of heated fluid that spans the entire width of the carrier film 710 (e.g., a planar stream of heated fluid), thereby providing heating of the entire surface area of the curable material 706 as the curable material 706 is conveyed past the heating element 746a by the carrier film 710. Alternatively, the heated fluid may span less than the entire width of the carrier film 710 (e.g., a focused stream of heated fluid), in which case the heated fluid may be scanned along the surface of the curable material 706 (e.g., by rotating and/or translating the heating element 746a relative to the curable material 706) to provide heating of the entire surface area of the curable material 706 as the curable material 706 is conveyed past the heating element 746a.

In some embodiments, the heating element 746a is stationary. For instance, the heating element 746a may remain in a fixed position and/or orientation while the curable material 706 is transported past the heating element 746a on the carrier film 710. Additionally or alternatively, the heating element 746a can be movable, such as rotatable and/or translatable. For instance, the heating element 746a can be configured to perform a sweeping motion from side-to-side to scan the heated fluid over the entire width of the carrier film 710. Alternatively, or in combination, a distance between the heating element 746a and the curable material 706 may be adjusted, such as to increase or decrease the separation between the heating element 746a and the curable material 706.

The various parameters of the heating element 746a may be adjusted before, during, and/or after the additive manufacturing process. For instance, the flow rate of the heating element 746a may be modulated during the additive manufacturing process. Moreover, the spread (e.g., coverage), position, and/or orientation of the heating element 746a may be adjusted, or these may be fixed parameters that remain constant throughout the additive manufacturing process. In some embodiments, some or all of these parameters are adjusted based on properties of the curable material 706, the rate of transport of the carrier film 710, observed bubble characteristics, and/or desired object characteristics.

In some embodiments, the heating element 746a includes a nozzle configured to influence the heating provided by the stream of heated fluid. For instance, the nozzle can be configured to redirect flow of the heated fluid, such as to focus the heated fluid, divert the heated fluid, and/or to create turbulent or laminar flow that may enhance heating of the curable material 706.

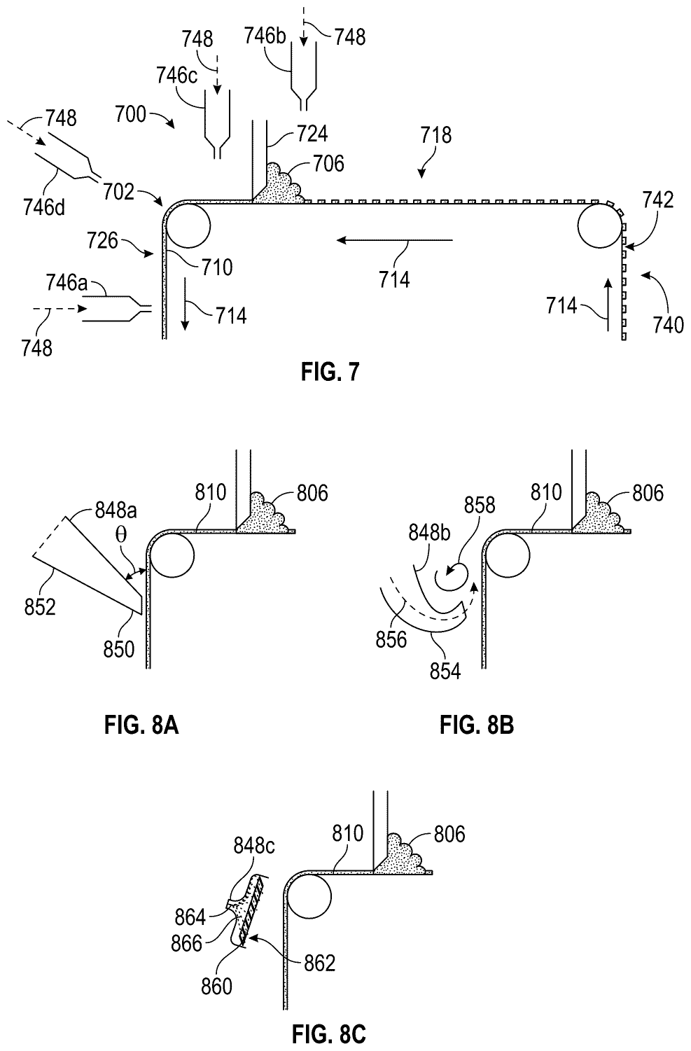

FIGS. 8A-8C illustrate various nozzle configurations suitable for use with the heating elements described herein, in accordance with embodiments of the present technology. Specifically, FIG. 8A is a partially schematic side view of a tapered nozzle 848a, FIG. 8B is a partially schematic side view of a curved nozzle 848b, and FIG. 8C is a partially schematic side view of a multi-channel nozzle 848c.

Referring now to FIG. 8A, the tapered nozzle 848a can be coupled to a heating element (e.g., the heating element 746 of FIG. 7) configured to output a stream of heated fluid toward a curable material 806 on a carrier film 810. In some embodiments, the tapered nozzle 848a is coupled to an end region (e.g., an outflow port) of the heating element, and heated fluid is output from the heating element through the tapered nozzle 848a. The tapered nozzle 848a can be oriented at an angle θ relative to the carrier film 810. For instance, the angle θ can be within a range from 0 to 30 degrees, 30 to 60 degrees, 60 to 90 degrees, 90 to 120 degrees, 120 to 150 degrees, and/or 150 to 180 degrees.

The tapered nozzle 848a can include a first section 850 having a smaller diameter than a second section 852. In some embodiments, the second section 852 is positioned closer to curable material 806 than the first section 850. For instance, the tapered nozzle 848a can be configured to reduce an area covered by the heated fluid (e.g., focus the heated fluid to a smaller area). However, in other embodiments, the tapered nozzle 848a can be inverted such that the first section 850 is closer to the curable material 806 than the second section 852. For instance, the tapered nozzle 848a can be configured to increase an area covered by the heated fluid (e.g., diffuse the heated fluid over a greater area).

Referring next to FIG. 8B, the curved nozzle 848b can be coupled to a heating element (e.g., the heating element 746 of FIG. 7) configured to output a stream of heated fluid toward the curable material 806 on the carrier film 810. In some embodiments, the curved nozzle 848b is coupled to an end region (e.g., an outflow port) of the heating element, and heated fluid is output from the heating element through the curved nozzle 848b. The curved nozzle 848b can include a curved section 854 configured to guide the heated fluid along a curved trajectory 856. In some embodiments, the curved trajectory 856 is curved in a direction opposite the direction in which the carrier film 810 carries the curable material 806. Alternatively, or in combination, the curved trajectory 856 can be curved along the direction in which the carrier film 810 carries the curable material 806. Further, the curved trajectory 856 can generate one or more vortices 858 proximate to the curable material 806, which may improve heat transfer to the curable material 806.

In some embodiments, the heated fluid can be delivered through multiple channels. Turning now to FIG. 8C, the multi-channel nozzle 848c can be coupled to a heating element (e.g., the heating element 746 of FIG. 7) configured to output a stream of heated fluid toward the curable material 806 on the carrier film 810. In some embodiments, the multi-channel nozzle 848c is coupled to an end region (e.g., an outflow port) of the heating element, and heated fluid can be output from the heating element through the multi-channel nozzle 848c. The multi-channel nozzle 848c can include a plurality of dividers 860 defining a plurality of channels 862. The dividers 860 can be positioned at an outlet of the multi-channel nozzle 848c and can be angled. The channels 862 can define flow paths for the heated fluid. For instance, the heated fluid can branch from a single initial stream 864 to a plurality of individual streams 866. The individual streams 866 can be configured to heat the curable material 806 at multiple locations. In some embodiments, the dividers 860 can be moved (e.g., translated and/or rotated) to adjust the flow direction of the individual streams 866. For instance, the dividers 860 can be configured to rotate within a range from 0 degrees to 30 degrees, 30 degrees to 60 degrees, 60 degrees to 90 degrees, 90 degrees to 120 degrees, 120 degrees to 150 degrees, 150 degrees to 180 degrees, etc. In some embodiments, the dividers 860 are configured to move between two alternating configurations to provide greater heat distribution to the curable material 806.

Additionally or alternatively, the heated fluid can be delivered through a nozzle which is a combination of a tapered nozzle 848a and a curved nozzle 848b, or a combination of a tapered nozzle 848a and a multi-channel nozzle 848c, or a combination of a curved nozzle 848b and a multi-channel nozzle 848c, etc.

Although the embodiments of FIGS. 7-8C are discussed above in terms of heating elements that output a stream of heated fluid to remove bubbles from a curable material, in other embodiments, bubble removal may be achieved with a non-heated stream of fluid (e.g., the fluid is at printing temperature, ambient temperature, or lower). In such instances, the fluid may be configured to promote bubble removal by applying pressure to the surface of the curable material to break the surface tension and/or to burst the bubbles.

FIG. 9 is a partially schematic side view of a system 900 for additive manufacturing configured in accordance with embodiments of the present technology. The system 900 is configured to fabricate one or more objects using an additive manufacturing process. In some embodiments, the system 900 is configured to increase the temperature of a curable material during the additive manufacturing process to reduce or prevent bubbles in the objects.

The system 900 includes a printer assembly 902 that forms an object on a build platform by applying energy to a curable material 906 (e.g., a photopolymerizable resin). In the illustrated embodiment, the printer assembly 902 includes a carrier film 910 configured to transport the curable material 906. For instance, the carrier film 910 can adhere to and carry a thin material layer of the curable material 906 in a continuous loop trajectory (e.g., along the directions indicated by arrows 914) through a deposition zone 918, pre-print zone 926, print zone (not depicted), and post-print zone 940.

In some embodiments, the curable material 906 is deposited on the carrier film 910 by a material source (not depicted) at the deposition zone 918. Alternatively, or in combination, the curable material 906 can be deposited on and/or into remaining curable material 906 on the carrier film 910. The remaining curable material 906 can include curable material 906 that is left on the carrier film 910 following curing and separation of one or more object portions, as discussed elsewhere herein. Accordingly, the remaining curable material 906 can include one or more recesses 942 corresponding to the separated object portion(s). As additional curable material 906 is deposited on and/or into the remaining curable material 906, one or more bubbles can form in the recesses 942. For instance, the additional curable material 906 can trap air or other gases in the recesses 942, e.g., as discussed above in connection with FIG. 4A.

In some embodiments, the system 900 further comprises a blade 924 positioned downstream of the material source. The blade 924 can be configured to smooth the curable material 906 over the remaining curable material 906 and/or adjust the layer height to a preferred height. As discussed above in connection with FIG. 4B, the presence of the blade 924 can cause the curable material 906 to build up behind the blade 924, and the built-up material 906 can also trap air or other gases within the recesses 942.

The system 900 can further include a heating element 946 configured to facilitate bubble removal from the curable material 906. The heating element 946 can be configured to heat the curable material 906 to an increased temperature that promotes bubble removal, e.g., by modifying one or more properties of the curable material 906. As discussed elsewhere herein, the modified properties can include a decreased viscosity of the curable material 906, a decreased surface tension of the curable material 906, and/or an increased bubble motility within the curable material 906, e.g., by creating a temperature gradient in the curable material 906. The heating element 946 can be positioned proximate to the printer assembly 902 (e.g., downstream of the material source and blade 924) to direct energy (e.g., thermal energy) toward the curable material 906 to heat the curable material 906, such as adjacent to the pre-print zone 926. In some embodiments, the carrier film 910 includes a first surface configured to support the curable material 906 and a second surface opposite the first surface, and the heating element 946 can be positioned closer to the first surface than the second surface.

In the illustrated embodiment, the heating element 946 includes an emitter 968 configured to emit an energy beam 970 (e.g., a laser beam or IR emitter) to heat the curable material 906. As shown in FIG. 9, the emitter 968 can direct the energy beam 970 toward a reflector 972 (e.g., a mirror), and the reflector 972 can be configured to direct the energy beam 970 toward the curable material 906 on the carrier film 910. The energy beam 970 can have any wavelength suitable for heating the curable material, such as a wavelength within a range from 750 nm to 15,000 nm, such as from 900 nm to 10,000 nm or from 950 nm to 3,000 nm. In some embodiments, the energy beam 970 has a wavelength that is highly absorbed by the curable material 906, e.g., the wavelength of the energy beam 970 is equal or similar to a peak in the absorption spectrum of the curable material 906. The intensity, wavelength, beam size, etc., of the energy beam 970 can be set to adjust the heating of the curable material 906 as desired.

In some embodiments, the reflector 972 is or includes a parabolic reflector. The parabolic reflector can be configured to receive the energy beam 970 from a variety of incident angles, e.g., within a range from 0 degrees to 30 degrees, 30 degrees to 60 degrees, 60 degrees to 90 degrees, 90 degrees to 120 degrees, 120 degrees to 150 degrees, 150 degrees to 180 degrees, etc. The parabolic reflector can reflect the energy beam 970 toward a focal point, which may be located on or near the surface of the curable material 906 at the pre-print zone 926. Alternatively or in combination, the reflector 972 can be or include a different type of reflector, such as spherical reflector, an elliptical reflector, a linear reflector, a hyperbolic reflector, a triangular reflector, etc.

Further, the reflector 972 can be configured to be movable, such as rotatable and/or translatable. For instance, the reflector 972 can be configured to rotate and/or translate such that the energy beam 970 is reflected toward different locations on the curable material 906. In some embodiments, the energy beam 970 is reflected in a pattern. For instance, as shown in the inset in FIG. 9, the energy beam 970 can be reflected along a scanning pattern 974 (e.g., a raster pattern) that moves back and forth along the width of the curable material 906 on the carrier film 910 to provide heating of the entire surface area of the curable material 906 as the curable material 906 is conveyed through the pre-print zone 926. In some embodiments, the emitter 968 projects a grid pattern onto the curable material 906. The grid can cover the whole or parts of the width of the carrier film 910 and can be adjusted in size and/or coverage.

While the emitter 968 is depicted in FIG. 9 as being directed toward the reflector 972, in some embodiments, the emitter 968 may alternatively or additionally be directed toward the curable material 906, e.g., without the reflector 972. For instance, the emitter 968 can be positioned proximate to the curable material 906 and oriented toward to the curable material 906. Further, while the emitter 968 and reflector 972 are illustrated as being configured to direct the energy beam 970 toward the pre-print zone 926, in other embodiments, the emitter 968 and reflector 972 can be configured to direct the energy beam 970 toward any suitable portion of the printer assembly 902, such as on or within the build platform 908, on or within the material source 916, the deposition zone 918, the print zone 928, the post-print zone 940, or combinations thereof.

FIG. 10 is a partially schematic side view of a system 1000 for additive manufacturing configured in accordance with embodiments of the present technology. The system 1000 is configured to fabricate one or more objects using an additive manufacturing process. In some embodiments, the system 1000 is configured to increase the temperature of a curable material during the additive manufacturing process to reduce or prevent bubbles in the objects.

The system 1000 includes a printer assembly 1002 that forms an object on a build platform by applying energy to a curable material 1006 (e.g., a photopolymerizable resin). In the illustrated embodiment, the printer assembly 1002 includes a carrier film 1010 configured to transport the curable material 1006. For instance, the carrier film 1010 can adhere to and carry a thin material layer of the curable material 1006 in a continuous loop trajectory (e.g., along the directions indicated by arrows 1014) through a deposition zone 1018, pre-print zone 1026, print zone 1028, and post-print zone 1040.

In some embodiments, the curable material 1006 is deposited on the carrier film 1010 by a material source 1016 at the deposition zone 1018. Alternatively, or in combination, the curable material 1006 can be deposited on and/or into the remaining curable material 1006 on the carrier film 1010. The remaining curable material 1006 can include curable material 1006 that is left on the carrier film 1010 following curing and separation of one or more object portions, as discussed elsewhere herein. Accordingly, the remaining curable material 1006 can include one or more recesses 1042 corresponding to the separated object portion(s). As additional curable material 1006 is deposited on and/or into the remaining curable material 1006, one or more bubbles can form in the recesses 1042. For instance, the additional curable material 1006 can trap air or other gases in the recesses 1042, e.g., as discussed above in connection with FIG. 4A.

In some embodiments, the system 1000 further comprises a blade 1024 positioned downstream of the material source. The blade 1024 can be configured to smooth the curable material 1006 over the remaining curable material 1006 and/or set a preferred height of the curable material 1006. As discussed above in connection with FIG. 4B, the presence of the blade 1024 can cause the curable material 1006 to build up behind the blade 1024, and the built-up material 1006 can also trap air or other gases within the recesses 1042.

The system 1000 can further include a cover 1078 at least partially surrounding the material source 1016 and/or the deposition zone 1018. In some embodiments, the cover 1078 at least partially encloses an environment 1080 through which the curable material 1006 is deposited into and/or passes through. For instance, the environment 1080 can include the portion of the deposition zone 1018 that is located above the carrier film 1010 and under the cover 1078.

In some embodiments, the system 1000 includes a heating element 1046 configured to heat the environment 1080. For instance, the heating element 1046 can increase the temperature of the air of the environment 1080 and/or the temperature of trapped gases (e.g., bubbles) within the curable material 1006, which can promote bubble motility and/or bursting. Additionally or alternatively, the heating of the environment 1080 can result in heat transfer to the curable material 1006. The heating element 1046 can be positioned proximate to the material source 1016, proximate and internal to the cover 1078, and/or proximate and external to the cover 1078. In some embodiments, the heating element 1046 is configured to heat the environment 1080 to a temperature sufficient to facilitate bubble removal, such as a temperature of at least 40° C., at least 50° C., at least 100° C., etc.

The cover 1078 can include one or more insulative materials to reduce the amount transferred from the environment 1080 to an external environment of the cover 1078, such as foams, reflective materials to direct heat back toward to the curable material 1006, etc. Additionally or alternatively, the cover 1078 can include one or more vents 1082 to allow heat to escape the environment 1080, e.g., to prevent excessive heating of the curable material 1006. Optionally, one or more air circulation devices (e.g., fans, blowers) can be positioned within or proximate to the cover 1078 to promote uniform heating of the environment 1080 and the curable material 1006.

Heating the environment 1080 can cause a heating of trapped gases in the curable material 1006 and/or the curable material 1006 itself. For instance, the environment 1080 can transfer heat to the curable material 1006 via thermal convection and/or radiation. As discussed elsewhere herein, heating of the curable material 1006 can promote bubble removal, e.g., by modifying one or more properties of the curable material 1006. The modified properties can include a decreased viscosity of the curable material 1006, a decreased surface tension of the curable material 1006, and/or an increased bubble motility within the curable material 1006. Further, by heating the environment 1080, the material source 1016, the blade 1024, and/or the carrier film 1010 can be heated. The heating of each of these components may further promote bubble removal by increasing the temperature of the curable material 1006.

Alternatively or in combination, the cover 1078 can be used to control the composition of the environment 1080, e.g., by introducing a gas that is less likely to form bubbles in the curable material 1006. For instance, a gas having lower density than air (e.g., helium) can be introduced into the environment 1080 within the cover 1078, such that any bubbles that are formed in the curable material 1006 are composed of the low-density gas and thus will be more likely to rise to the surface of the curable material 1006 and burst. In such embodiments, the environment 1080 may or may not be heated.

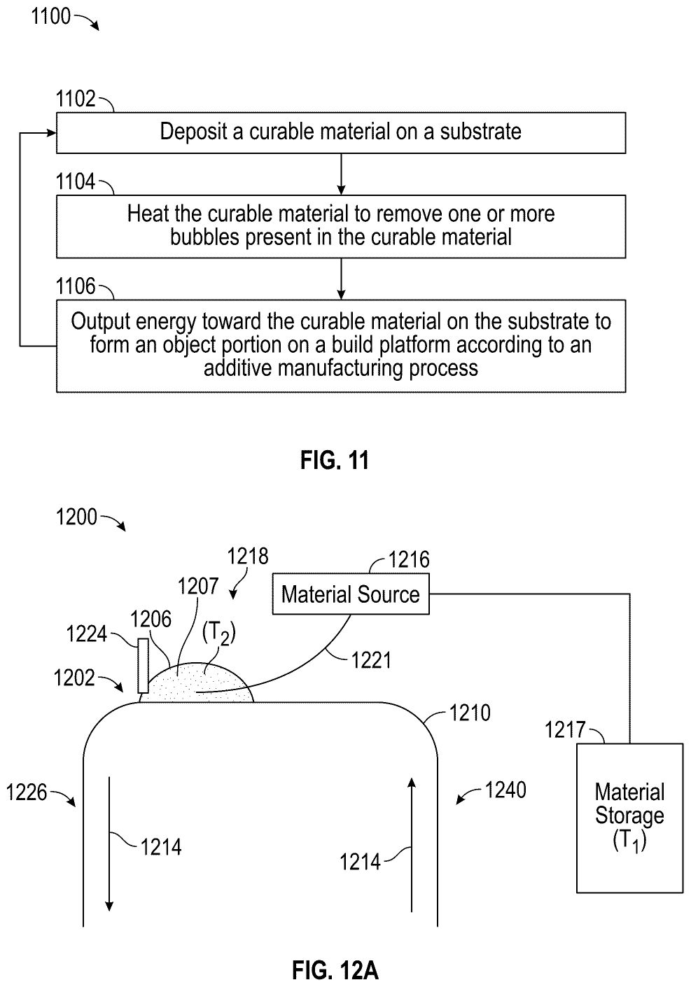

FIG. 11 is a flow diagram illustrating a method 1100 for bubble prevention and/or removal during an additive manufacturing process, in accordance with embodiments of the present technology. The method 1100 can be used to heat a curable material to remove one or more bubbles in the curable material, thereby reducing or eliminating bubbles present in an additively manufactured object fabricated from the curable material (e.g., a dental appliance). The method 1100 can be performed using any of the systems and devices described herein, such as any of the embodiments of FIGS. 6-10. In some embodiments, some or all of the processes of the method 1100 are implemented as computer-readable instructions (e.g., program code) that are configured to be executed by one or more processors of a computing device, such as a controller of an additive manufacturing system (e.g., the controller 638 of the system 600 of FIG. 6). The method 1100 can be combined with any of the methods described herein.

The method 1100 can begin at block 1102 with depositing a curable material on a substrate. In some embodiments, the curable material is or includes a photopolymerizable resin. The curable material can be deposited on the substrate from a material source, e.g., such as a nozzle coupled to a reservoir of the curable material. Optionally, the deposited curable material can be smoothed into a thin, uniform material layer on the substrate using one or more blades, with the thickness of the material layer being larger or substantially equivalent to the thickness of an object portion to be formed. The substrate can be any structure suitable for supporting the deposited curable material, such as a film, plate, etc. In some embodiments, the substrate is a movable substrate that circulates the curable material toward an energy source for curing, such as a carrier film, movable plate, etc. Alternatively, the substrate can be a stationary substrate having a fixed position and orientation.

In some embodiments, the deposited curable material includes one or more bubbles. As described elsewhere herein, bubbles may form in the curable material when the curable material is deposited into recesses in previously deposited curable material (e.g., imprints left when separating cured object portions from surrounding uncured material); when the curable material is smoothed over the recesses by a blade or similar device; due to presence of dissolved gases in the curable material; due to pressure differences between the curable material and the surrounding environment; etc. For instance, highly viscous curable materials (e.g., resins) may be particularly prone to bubble formation and/or it may be difficult for bubbles to escape from such highly viscous material and/or materials with high surface tension. However, it will be appreciated that the method 1100 can also be applied to low viscosity materials.

The method 1100 can continue at block 1104 with heating at least a portion of the curable material to remove one or more bubbles present in the curable material. The heating can promote bubble removal, e.g., by reducing the viscosity and/or surface tension of the curable material to enhance bubble motility and bursting. Additionally or alternatively, the heating can cause the bubbles to migrate from lower-temperature portions of the curable material to higher-temperature portions of the curable material, e.g., due to thermophoresis. In some embodiments, the at least a portion of the curable material has an elevated temperature that can be at least 40° C., 50° C., 60° C., 70° C., 80° C., 90° C., 100° C., 120° C., 150° C., 200° C., etc. The heating can be performed at any suitable stage in the additive manufacturing process, such as before, concurrently with, or after deposition of the curable material onto the substrate.

The heating can be performed using one or more heating elements, such as heat guns, heated air knives, heating plates, infrared lamps, laser emitters, resistive heaters, etc. The heating element(s) can heat the curable material in various ways, such as by outputting heated fluid toward the curable material; directing an energy beam onto the curable material; heating an environment proximate to the curable material; heating a material source that deposits the curable material onto the substrate; heating a blade, carrier film, or other element that comes into direct contact with the curable material; etc. For example, the heating elements can be configured according to any of the embodiments of FIGS. 6-10.

The heating can remove some or all of the bubbles that were initially present in the curable material, such as at least 50%, 75%, 80%, 85%, 90%, 95%, or 99% of the bubbles (e.g., macroscopic bubbles). In some embodiments, the heating eliminates most or all of the bubbles in the curable material having a diameter greater than or equal to 1 mm, 500 μm, 250 μm, 100 μm, 75 μm, 50 μm, 25 μm, or 10 μm. In some embodiments, after heating, the curable material includes no more than 100 bubbles/mL, 50 bubbles/mL, 25 bubbles/mL, 10 bubbles/mL, or 5 bubbles/mL.

The method 1100 can continue at block 1106 with outputting energy toward the curable material on the substrate to form an object portion on a build platform according to an additive manufacturing process. For example, an energy source (e.g., a laser, projector, light engine) can output energy to at least partially cure the curable material to form the object portion. The energy can be patterned or scanned onto the curable material in a geometry corresponding to the desired geometry for the object portion. In some embodiments, the energy source directs energy through the substrate to reach the curable material, and the substrate is partially or fully transparent to the wavelength of energy produced by the energy source. As noted above, the curable material can be substantially free of bubbles at the time of curing, such that the resulting object portion includes few or no bubbles that may compromise the mechanical integrity, function, and/or aesthetics of the resulting object.

The process of blocks 1102-1106 can be repeated multiple times to build up the object geometry in a layer-by-layer manner. In some embodiments, after an object portion is formed according to the process of block 1106, the cured object portion can be separated from the remaining curable material on the substrate, thus leaving a recess in the curable material. Additional curable material can then be deposited onto the substrate and the curable material can be smoothed into a uniform material layer, according to the process of block 1102. Bubbles that are formed in the new material layer can subsequently be removed by heating the curable material, according to the process of block 1104. This process can be repeated until the entire object geometry has been produced.

The method 1100 illustrated in FIG. 11 can be modified in many different ways. For example, although the above processes of the method 1100 are described with respect to a single object, the method 1100 can be used to sequentially or concurrently fabricate any suitable number of objects, such as tens, hundreds, or thousands of additively manufactured objects. As another example, the ordering of the processes shown in FIG. 11 can be varied, and/or some of the processes of the method 1100 can be omitted. Additionally, the method 1100 can include processes not shown in FIG. 11, such as other techniques for removing bubbles from the curable material (e.g., as discussed further below in connection with FIGS. 12A-16), heating of the curable material to a printing temperature (which may be different than the temperature for bubble removal), etc. For instance, the method 1100 can include applying a vacuum to the curable material to facilitate bubble removal, alternatively or in addition to heating the curable material. Moreover, the method 1100 can alternatively or additionally include cooling a portion of the curable material, e.g., to create a temperature gradient that facilitates bubble removal via thermophoresis as discussed elsewhere herein.

In some embodiments, it may be desirable to additionally or alternatively prevent bubble formation during deposition of curable material on a substrate. For instance, as discussed above with respect to FIG. 4D, bubbles can form during deposition when curable material is deposited on residual curable material in a deposition zone of an additive manufacturing system. This may be due to the trapping of air or other gases in between the deposited curable material and the residual curable material. In some embodiments of the present technology, delivering the curable material directly into the residual curable material (also referred to herein as “direct material feeding”) can reduce or prevent bubble formation during deposition.

FIGS. 12A-12E illustrate representative examples of additive manufacturing systems with direct material feeding for bubble prevention, in accordance with embodiments of the present technology. Specifically, FIG. 12A is a partially schematic side view of a system 1200 for additive manufacturing, FIG. 12B is a close-up view of a portion of the system 1200, FIG. 12C is a top view of a portion of the system 1200, FIG. 12D is a close-up view of the system 1200, and FIG. 12E is a close-up view of the system 1200. The systems of FIGS. 12A-12E can be generally similar to the system 600 described above with respect to FIG. 6 and/or the systems of FIGS. 7-10. Accordingly, like numbers (e.g., printer assembly 602 versus printer assembly 1202) are used to identify similar or identical elements, and the discussion of the systems of FIGS. 12A-12E will be limited to those features that are different from and/or that were not already discussed with respect to FIGS. 6-10.

FIG. 12A is a partially schematic side view of a system 1200 for additive manufacturing configured in accordance with embodiments of the present technology. The system 1200 is configured to fabricate one or more objects using an additive manufacturing process. In some embodiments, the system 1200 is configured to reduce or prevent bubble formation in a curable material 1206 during the additive manufacturing process.

The system 1200 includes a printer assembly 1202 that forms an object on a build platform by applying energy to a curable material 1206 (e.g., a photopolymerizable resin). In the illustrated embodiment, the printer assembly 1202 includes a carrier film 1210 configured to transport the curable material 1206. For instance, the carrier film 1210 can adhere to and carry a thin material layer of the curable material 1206 (the layer is not shown in FIG. 12A merely for purposes of simplicity) in a continuous loop trajectory (e.g., along the directions indicated by arrows 1214) through a deposition zone 1218, pre-print zone 1226, print zone (not depicted), and post-print zone 1240.

In some embodiments, the printer assembly 1202 further includes a blade 1224. The blade 1224 can be positioned within the deposition zone 1218. The blade 1224 can be configured to smooth curable material 1206 on the carrier film 1210 or to adjust a height of the curable material 1206 on the carrier film 1210. In some embodiments, the blade 1224 creates a flow restriction that causes the curable material 1206 to accumulate (hereafter referred to as “accumulated material 1207”) in the deposition zone 1218 behind the blade 1224. The height of the accumulated material 1207 can be significantly greater than the layer height of the curable material 1206, e.g., at least 0.5 mm, 1 mm, 2 mm, 3 mm, 4 mm, 5 mm, 10 mm, 20 mm, etc.

In some embodiments, additional curable material 1206 is deposited by a material source 1216 directly into the accumulated material 1207. For instance, the material source 1216 can be connected to a material storage 1217 (e.g., a larger reservoir, vat, tank, etc., of the curable material 1206) and a material feed 1221. The material source 1216 can be configured to receive the additional curable material 1206 from the material storage 1217 and output the additional curable material 1206 via the material feed 1221. In some embodiments, the material feed 1221 can be configured to transport the additional curable material 1206 to the accumulated material 1207. For instance, the additional curable material 1206 can be delivered directly into the accumulated material 1207 via the material feed 1221, without exposing the additional curable material 1206 to the environment. As best seen in FIG. 12B, the material feed 1221 can be an elongated tube (e.g., polyethylene tubing) including a first end 1223 connected to the material source 1216 and a second end 1225 that is inserted into the accumulated material 1207 to directly dispense the curable material 1206 into the accumulated material 1207. The height of the accumulated material 1207 can be sufficiently high to allow the second end 1225 to be completely immersed within the accumulated material 1207. The direct delivery of the additional curable material 1206 into the accumulated material 1207 via the material feed 1221 can prevent the formation of bubbles in the additional curable material 1206 and/or the accumulated material 1207, e.g., by reducing the trapping of air or other gases between the additional curable material 1206 and the accumulated material 1207. Other advantages of direct delivery can include improved control over material dispensing and/or increased safety.

In some embodiments, the material feed 1221 can be configured to facilitate and/or promote a temperature gradient between the additional curable material 1206 in the material storage 1217 and the accumulated material 1207 on the carrier film 1210. For instance, the additional curable material 1206 in the material storage 1217 may have a first temperature T₁, and the accumulated material on the carrier film 1210 may have a second temperature T₂. In some embodiments, the first temperature T₁ is less than the second temperature T₂, and a temperature gradient is established therebetween at least in part due to the flow of the additional curable material 1206 through the material feed 1221.

The temperature gradient can provide a gradual transition in temperature from the additional curable material 1206 to the accumulated material 1207 (e.g., as depicted in FIG. 12B). The gradual transition in temperature may reduce the likelihood of bubble formation in the additional curable material 1206 and/or the accumulated material 1207. For instance, without a gradual transition in temperature, the additional curable material 1206 and the accumulated material 1207 may have substantial differences in temperature, and accordingly may have differences in viscosities resulting in impaired miscibility and bubble formation, as discussed elsewhere herein. Moreover, the gradual temperature transition produced by the material feed 1221 can obviate the need for separate components to create such a transition, such as heating elements, sensors, etc., thereby simplifying the additive manufacturing process. Moreover, the material storage 1217 can be maintained at a lower temperature T₁, which may improve material stability and/or reduce energy consumption.

In some embodiments, the material feed 1221 has a decreasing diameter from a first end 1223 coupled to the material source 1216 to a second end 1225 inserted into the accumulated material 1207. For instance, as depicted in FIG. 12C, the first end 1223 has a larger diameter than the second end 1225. In some embodiments, the decreasing diameter of the material feed 1221 from the first end 1223 to the second end 1225 can produce an increasing surface-to-volume ratio of the additional curable material 1206 from the first end 1223 to the second end 1225, thereby improving temperature equalization.

Turning now to FIG. 12D, the system 1200 can alternatively or additionally include a reservoir 1227 positioned upstream of the accumulated material 1207 in the deposition zone 1218. In some embodiments, the reservoir 1227 is configured to pool additional curable material 1206 (hereafter referred to as “pooled material 1209”). The height of the pooled material 1209 can be significantly greater than the layer height of the curable material 1206, e.g., at least 0.5 mm, 1 mm, 2 mm, 3 mm, 4 mm, 5 mm, 10 mm, 20 mm, etc. The increased height can allow for direct dispensing of the additional curable material 1206 into the pooled material 1209, e.g., by inserting the material feed 1221 into the pooled material 1209 in the reservoir 1227. This can be advantageous, for example, in situations where direct dispensing into the accumulated material 1207 may interfere with the additive manufacturing process. Moreover, direct dispensing into the reservoir 1227 can also improve the temperature equalization of the additional curable material 1206, e.g., the greater distance between the reservoir 1227 and the blade 1224 can give the curable material 1206 more time to reach the coating temperature T₂, thus producing a more gradual temperature transition that may further reduce bubble formation.

In some embodiments, the pooled material 1209 is sourced from the material feed 1221, e.g., the reservoir 1227 is filled with only the additional curable material 1206 (as depicted in FIG. 12D). Alternatively or additionally, the reservoir 1227 can additionally be configured to pool residual curable material 1206 circulating back to the deposition zone 1218 from the post-print zone 1240. For example, as depicted in FIG. 12E, residual curable material 1206 transported toward the reservoir 1227 from the post-print zone 1240 can also be directed into the reservoir 1227 (e.g., via inclusion of a ramp 1229 at the upstream side of the reservoir 1227), which can further increase the height of the pooled material 1209 to facilitate direct dispensing of additional curable material 1206 into the pooled material 1209.

Although certain embodiments of the present technology use heating to remove bubbles from an additional curable material and/or direct dispensing of additional curable material to avoid bubble formation, the systems and methods herein can alternatively or additionally use other approaches to prevent bubbles from forming in the additional curable material. For instance, as discussed above with respect to FIGS. 4A and 4B, deposition of additional curable material into preexisting recesses may be a significant mechanism of bubble formation. This mechanism can be reduced or mitigated by eliminating some or all of the recesses present in the additional curable material before the deposition of additional curable material. In some embodiments, the systems and methods described herein utilize a device that physically abuts the substrate to scrape the additional curable material off the substrate in a manner that eliminates the recesses, which may be prone to bubble formation as discussed above.

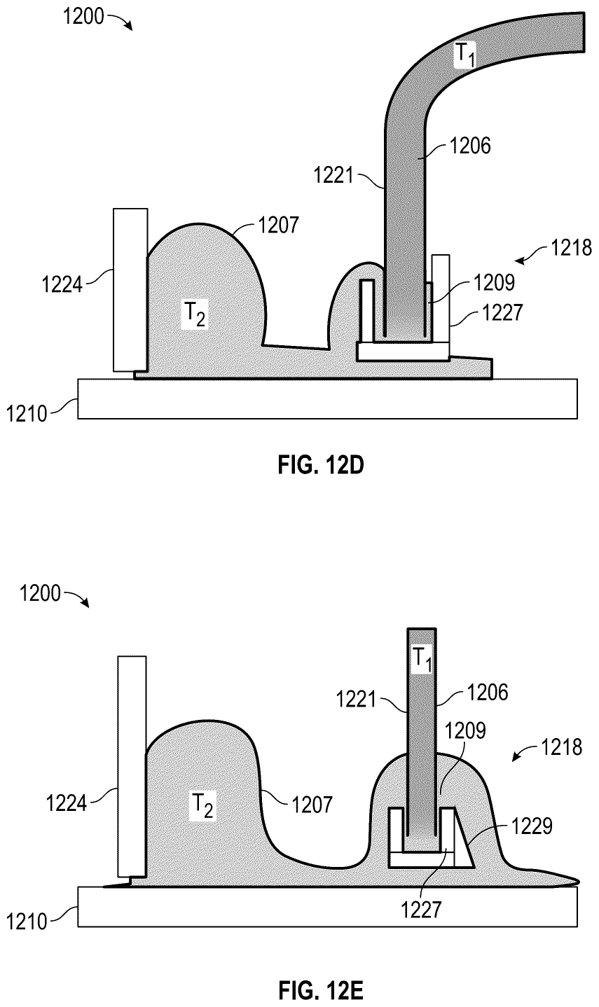

FIG. 13 is a partially schematic side view of a system 1300 for additive manufacturing configured in accordance with embodiments of the present technology. The system 1300 is configured to fabricate one or more objects 1304 using an additive manufacturing process. In some embodiments, the system 1300 is configured to remove recesses in a curable material 1306 during the additive manufacturing process to prevent bubbles in the objects 1304 that might otherwise form due to the presence of recesses. The system of FIG. 13 can be generally similar to the system 600 described above with respect to FIG. 6. Accordingly, like numbers (e.g., printer assembly 602 versus printer assembly 1302) are used to identify similar or identical elements, and the discussion of the system 1300 will be limited to those features that are different from and/or that were not already discussed with respect to FIG. 6.

The system 1300 includes a printer assembly 1302 that forms an object 1304 on a build platform 1308 by applying energy to a curable material 1306 (e.g., a photopolymerizable resin). In the illustrated embodiment, the printer assembly 1302 includes a carrier film 1310 configured to transport the curable material 1306. For instance, the carrier film 1310 can adhere to and carry a thin material layer of the curable material 1306 in a continuous loop trajectory (e.g., along the directions indicated by arrows 1314) through a deposition zone 1318, pre-print zone 1326, print zone 1328, and post-print zone 1340. Although the carrier film 1310 is depicted as being coupled to four rollers 1312 that rotate to circulate the carrier film 1310 along the loop trajectory, the printer assembly 1302 can optionally include a different number of rollers (e.g., six rollers 1312, e.g., similar to the configuration depicted in FIG. 6). In some embodiments, one or more of the rollers 1312 can include geometries having edges, wires, rounded corners or other geometrical or mechanical features suitable to guide or support the carrier film 1310 in the additive manufacturing process.

In some embodiments, the curable material 1306 is deposited on the carrier film 1310 by a material source 1316 at the deposition zone 1318. Alternatively, or in combination, the curable material 1306 can be deposited on and/or into remaining curable material 1306 on the carrier film 1310. The remaining curable material 1306 can include curable material 1306 that is left on the carrier film 1310 following curing and separation of one or more object portions, as discussed elsewhere herein. Accordingly, the remaining curable material 1306 can include one or more recesses 1342 corresponding to the separated object portion(s). As additional curable material 1306 is deposited on and/or into the remaining curable material 1306, one or more bubbles can form in the recesses 1342. For instance, the additional curable material 1306 can trap air or other gases in the recesses 1342, e.g., as discussed above in connection with FIG. 4A.

To prevent the formation of bubbles, the system 1300 can further include an elongated shaft 1384 configured to remove the recesses 1342 before additional curable material 1306 is deposited on and/or into the remaining curable material 1306. For instance, the elongated shaft 1384 can be positioned downstream of the energy source 1330 and upstream of the material source 1316 (e.g., in the deposition zone 1318 before the material source 1316). The elongated shaft 1384 can be configured to displace the remaining curable material 1306 from the carrier film 1310 and onto the elongated shaft 1384. For instance, the elongated shaft 1384 can extend across the width of the carrier film 1310 in an orientation that is orthogonal to or angled relative to the direction of motion of the carrier film 1310. Accordingly, circulation of the carrier film 1310 can bring the curable material 1306 into contact with the elongated shaft 1384. The elongated shaft 1384 can be positioned against the surface of the carrier film 1310 to scrape the curable material 1306 off the surface of the carrier film 1310. The displaced curable material 1306 can then flow over the elongated shaft 1384 and back onto the carrier film 1310, thus eliminating the recesses 1342 to reform a smooth continuous material layer.

The elongated shaft 1384 can be any structure suitable for displacing the curable material 1306 off the carrier film 1310 while also being sufficiently thin to allow the curable material 1306 to flow continuously over the elongated shaft 1384. For instance, the elongated shaft 1384 can be or include a wire, rod, staff, bar, thread, wiper, beam, etc. Optionally, the elongated shaft 1384 can be coupled to frame or similar device (not shown) that presses or pulls the elongated shaft 1384 downward against the surface of the carrier film 1310. In some embodiments, the elongated shaft 1384 is cylindrical, while in other embodiments, the elongated shaft can have a different geometry (e.g., a semicircular, oval, square, rectangular, or other cross-sectional shape). The elongated shaft 1384 can have a cross-sectional size (e.g., height and/or diameter) that is less than or equal to 10 mm, 5 mm, 2 mm, 1.5 mm, 1 mm, 0.75 mm, 0.5 mm, 0.25 mm, or 0.1 mm. In some embodiments, for example, the elongated shaft 1384 has a cross-sectional size greater than 0.5 mm, such as greater than 1 mm or greater than 7 mm. In some embodiments, the curable material 1306 flows over the elongated shaft 1384 at a flow rate similar to the movement rate of the carrier film 1310, e.g., the flow rate over the elongated shaft 1384 can be at least 10%, 20%, 30%, 40%, 50%, 60%, 70%, 80%, 90%, 95%, or 99% of the movement rate of the carrier film 1310.

In some embodiments, the elongated shaft 1384 is stationary relative to the carrier film 1310. For instance, the elongated shaft 1384 can be mounted on the printer assembly 1302 proximate to the deposition zone 1318. The carrier film 1310 can cause the curable material 1306 to abut the elongated shaft 1384 as the carrier film 1310 passes through the deposition zone 1318. Alternatively or in combination, the elongated shaft 1384 can be movable (e.g., translatable, rotatable) relative to the carrier film 1310. For instance, the elongated shaft 1384 may be mounted to the printer assembly 1302 via an actuator, such as mechanical arm. The actuator can be configured to move the elongated shaft 1384 relative to the carrier film 1310, such as to temporarily scrape the curable material 1306 off the carrier film 1310. In some embodiments, the elongated shaft 1384 displaces the curable material 1306 from the carrier film 1310 in a sweeping motion. Optionally, the elongated shaft 1384 may be configured to rotate about a longitudinal axis of the elongated shaft 1384. For instance, as the curable material 1306 contacts the elongated shaft 1384, the elongated shaft 1384 can rotate to carry the curable material 1306. In some embodiments, the rotation of the elongated shaft 1384 can allow for the curable material 1306 to temporarily pool (e.g., aggregate, coalesce) on the elongated shaft 1384 before being deposited back onto the carrier film 1310. This can be useful, for instance, to ensure the remaining curable material 1306 is deposited back onto the carrier film 1310 continuously (e.g., without forming additional recesses 1342).

Further, the elongated shaft 1384 can optionally be heated, such as with a heating element as discussed elsewhere herein. In such embodiments, the elongated shaft 1384 can be made out of a metal to facilitate heating of the elongated shaft 1384 and heat transfer to the curable material 1306. Heating the elongated shaft 1384 can increase the flowability of the curable material 1306 over the elongated shaft 1384. For instance, the heating may lower the viscosity of the curable material 1306 and promote bubble removal, as discussed above with reference to FIGS. 5A-10. In some embodiments, the elongated shaft 1384 is configured to both displace the curable material 1306 and increase a temperature of the curable material 1306. In some embodiments, the elongated shaft 1384 can be made out of ceramic or other inert material with sufficient thermal conductivity to facilitate heating without influencing the material chemistry.

Although FIG. 13 illustrates a system 1300 including a single elongated shaft 1384, the system 1300 can include any suitable number of elongated shafts 1384, such as two, three, four, five or more elongated shafts 1384. Moreover, although the elongated shaft 1384 is depicted as being located in the deposition zone 1318, the elongated shaft 1384 can alternatively or additionally be positioned at other locations, such as the post-print zone 1340. Optionally, the system 1300 can include other mechanisms for removing and/or preventing bubbles, such as one or more heating elements, a vacuum, etc.

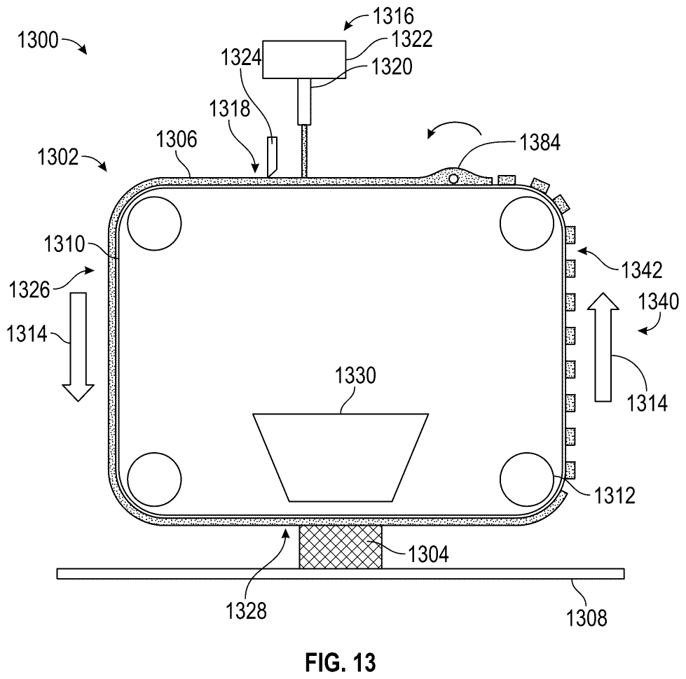

FIG. 14 is a flow diagram illustrating a method 1400 for bubble prevention and/or removal during an additive manufacturing process, in accordance with embodiments of the present technology. The method 1400 can be used to remove one or more recesses (e.g., imprints) in a curable material, thereby reducing or eliminating bubbles present in an additively manufactured object fabricated from the curable material (e.g., a dental appliance). The method 1400 can be performed using any of the systems and devices described herein, such as the embodiment of FIG. 12. In some embodiments, some or all of the processes of the method 1400 are implemented as computer-readable instructions (e.g., program code) that are configured to be executed by one or more processors of a computing device, such as a controller of an additive manufacturing system (e.g., a controller of the system 1200 of FIG. 12). The method 1400 can be combined with any of the methods described herein, such as the method 1100 of FIG. 11.

The method 1400 can begin at block 1402 with depositing a curable material on a substrate. In some embodiments, the curable material is or includes a photopolymerizable resin. The curable material can be deposited on the substrate from a material source, e.g., such as a nozzle coupled to a reservoir of the curable material. Optionally, the deposited curable material can be smoothed into a thin, uniform material layer on the substrate using one or more blades, with the thickness of the material layer being larger than or corresponding to the thickness of an object portion to be formed. The substrate can be any structure suitable for supporting the deposited curable material, such as a film, plate, etc. In some embodiments, the substrate is a movable substrate that circulates the curable material toward an energy source for curing, such as a carrier film, movable plate, etc. Alternatively, the substrate can be a stationary substrate having a fixed position and orientation.

At block 1404, the method 1400 can include outputting energy toward the curable material on the substrate to form an object portion on a build platform according to an additive manufacturing process. For example, an energy source (e.g., a laser, projector, light engine) can output energy to at least partially cure the curable material to form the object portion. The energy can be patterned or scanned onto the curable material in a geometry corresponding to the desired geometry for the object portion. In some embodiments, the energy source directs energy through the substrate to reach the curable material, and the substrate is partially or fully transparent to the wavelength of energy produced by the energy source.

At block 1406, the method 1400 can continue with separating the object portion from residual curable material on the substrate. The separation can be performed by moving the build platform away from the residual curable material and substrate, by moving the residual curable material and substrate away from the build platform, or both. The object portion can adhere to the build platform, while the residual curable material remains adhered to the substrate. After the separation, the residual curable can include a recess formed therein corresponding to the separated object portion. The recess may be prone to trapping air or other gases leading to bubble formation, as discussed herein.

At block 1408, the method 1400 can include displacing the residual curable material using an elongated shaft to eliminate the recess from the curable material. In some embodiments, for example, the displaced residual curable material flows over the elongated shaft and fills in the recess. The elongated shaft can be a wire, rod, staff, bar, thread, beam, wiper, etc., having a sufficiently small cross-sectional size to allow the curable material to flow over the elongated shaft, such as a height and/or diameter less than or equal to 10 mm, 5 mm, 2 mm, 1.5 mm, 1 mm, 0.75 mm, 0.5 mm, 0.25 mm, or 0.1 mm. Alternatively, the elongated shaft 1384 has a cross-sectional size greater than 0.5 mm, such as greater than 1 mm or greater than 7 mm. The flowing of the curable material over the elongated shaft can cause the curable material to coalesce to form a smooth material layer on the substrate without the recess.

In some embodiments, the displacement of the curable material is caused by movement of the elongated shaft relative to the substrate, e.g., the elongated shaft may remain stationary while the substrate moves, the elongated shaft may move while the substrate remains stationary, or both the elongated shaft and substrate may move. The elongated shaft can be positioned against the substrate such that the relative movement causes the elongated shaft to physically abut and scrape the curable material off the substrate.

Subsequently, the method 1400 can return to block 1402 to deposit additional curable material on the substrate in preparation for forming the next portion of the object. Because the recess has been removed from the residual curable material, the deposition of the additional curable material may produce few or no bubbles in the curable material. In some embodiments, after deposition, the curable material includes no more than 100 bubbles/mL, 50 bubbles/mL, 25 bubbles/mL, 10 bubbles/mL, or 5 bubbles/mL. In some embodiments, the processes of the method 1400 eliminate most or all of the bubbles in the curable material having a diameter greater than or equal to 1 mm, 500 μm, 250 μm, 100 μm, 75 μm, 50 μm, 25 μm, or 10 μm. The processes of blocks 1402-1408 can thus be repeated multiple times to build up the object geometry in a layer-by-layer manner, until the entire object geometry has been produced.

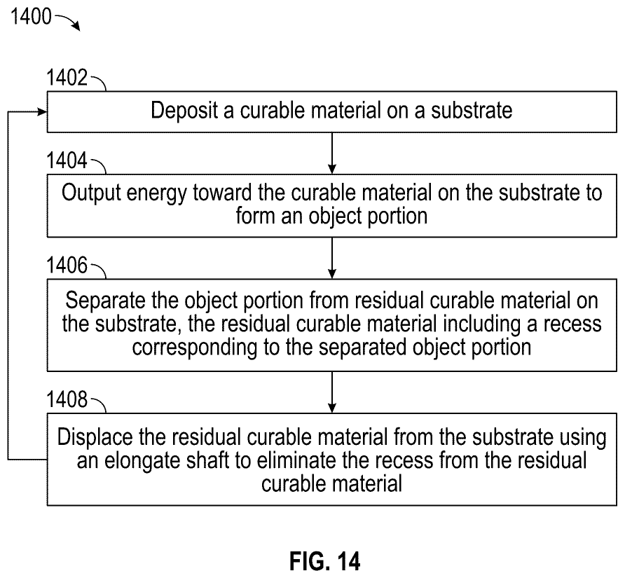

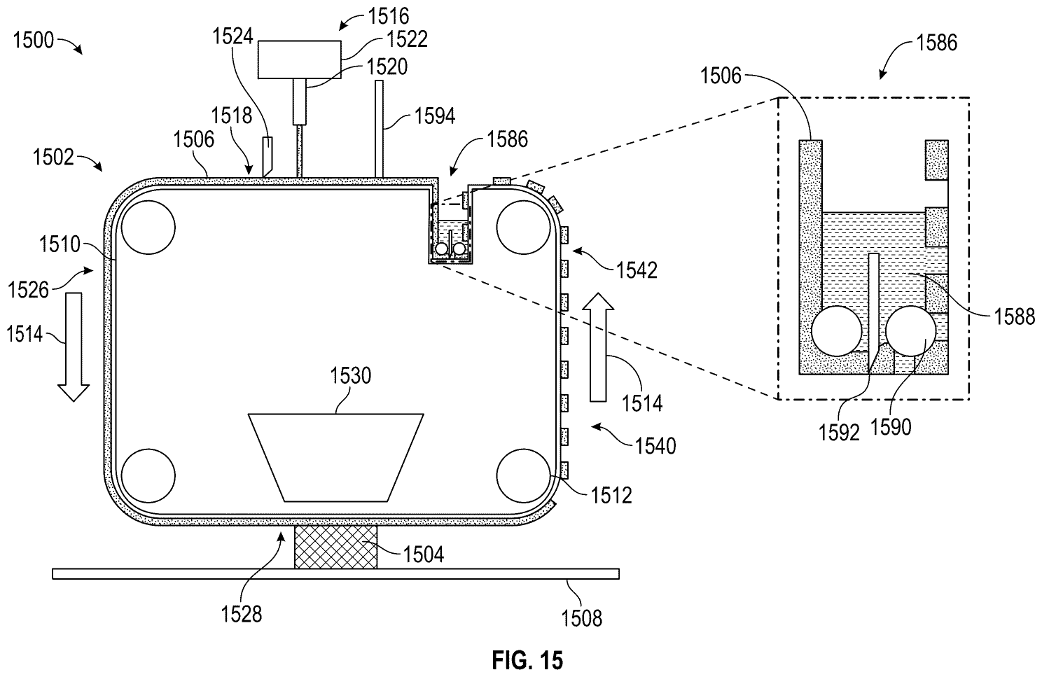

The method 1400 illustrated in FIG. 14 can be modified in many different ways. For example, although the above processes of the method 1400 are described with respect to a single object, the method 1400 can be used to sequentially or concurrently fabricate any suitable number of objects, such as tens, hundreds, or thousands of additively manufactured objects. As another example, the ordering of the processes shown in FIG. 14 can be varied, and/or some of the processes of the method 1400 can be omitted. Additionally, the method 1400 can include processes not shown in FIG. 14, such as other techniques for removing bubbles from the curable material (e.g., as previously discussed in connection with FIGS. 6-12E and/or as discussed further below in connection with FIGS. 15 and 16), heating of the curable material to a printing temperature, etc. For instance, the method 1400 can include applying a vacuum to the curable material to facilitate bubble removal, alternatively or in addition to removing recesses using the elongated shaft.

FIG. 15 is a partially schematic side view of a system 1500 for additive manufacturing configured in accordance with embodiments of the present technology. The system 1500 is configured to fabricate one or more objects 1504 using an additive manufacturing process. In some embodiments, the system 1500 is configured to remove recesses in a curable material 1506 during the additive manufacturing process while the curable material 1506 is isolated from air to prevent bubbles in the objects 1504 that might otherwise form due to the presence of recesses. The system of FIG. 15 can be generally similar to the system 600 described above with respect to FIG. 6. Accordingly, like numbers (e.g., printer assembly 602 versus printer assembly 1502) are used to identify similar or identical elements, and the discussion of the system 1500 will be limited to those features that are different from and/or that were not already discussed with respect to FIG. 6.

The system 1500 includes a printer assembly 1502 that forms an object 1504 on a build platform 1508 by applying energy to a curable material 1506 (e.g., a photopolymerizable resin). In the illustrated embodiment, the printer assembly 1502 includes a carrier film 1510 configured to transport the curable material 1506. For instance, the carrier film 1510 can adhere to and carry a thin material layer of the curable material 1506 in a continuous loop trajectory (e.g., along the directions indicated by arrows 1514) through a deposition zone 1518, pre-print zone 1526, print zone 1528, and post-print zone 1540. Although the carrier film 1510 is depicted as being coupled to four rollers 1512 that rotate to circulate the carrier film 1510 along the loop trajectory, the printer assembly 1502 can optionally include a different number of rollers (e.g., six rollers 1512, e.g., similar to the configuration depicted in FIG. 6). The rollers can include any suitable geometry for facilitating the movement of the carrier film 1510. For instance, the rollers can include cylinders, spools, blades, etc.

In some embodiments, the curable material 1506 is deposited on the carrier film 1510 by a material source 1516 at the deposition zone 1518. Alternatively, or in combination, the curable material 1506 can be deposited on or into remaining curable material 1506 on the carrier film 1510. The remaining curable material 1506 can include curable material 1506 that is left on the carrier film 1510 following curing and separation of one or more object portions, as discussed elsewhere herein. Accordingly, the remaining curable material 1506 can include one or more recesses 1542 corresponding to the separated object portion(s). As additional curable material 1506 is deposited on the remaining curable material 1506, one or more bubbles can form in the recesses 1542. For instance, the additional curable material 1506 can trap air or other gases in the recesses 1542, e.g., as discussed above in connection with FIG. 4A.

To prevent the formation of bubbles, the system 1500 can be configured to isolate the curable material 1506 from ambient air via a solvent while the recesses 1542 are removed from the curable material 1506. In some embodiments, the carrier film 1510 is configured to carry the curable material 1506 through a solvent reservoir 1586 containing a solvent 1588. In some embodiments, the solvent reservoir 1586 is positioned in the deposition zone 1518, e.g., downstream of the energy source 1530 and upstream of the material source 1516.

The solvent 1588 in the solvent reservoir 1586 can be a fluid or gel that is incompatible with (e.g., immiscible with) the curable material 1506, such that any bubbles of the solvent 1588 that form within the curable material 1506 will automatically separate from the curable material 1506, e.g., by rising to the surface of the curable material 1506 and bursting. Optionally, the solvent 1588 can have a low vapor pressure and/or can have a lower density than the curable material 1506 to facilitate separation of the solvent 1588 from the curable material 1506. Examples of materials that may be used for the solvent 1588 include silicone-based materials (e.g., polydimethylsiloxane, silicone oil), ionic liquids, polyether or dialkyl ethers, hydrocarbon (e.g., hydrogenated polybutadiene), materials with low viscosity and/or low vapor pressure, etc. In some embodiments, the fluid has a vapor pressure less than 0.1 mmHg at 70° C.

As the curable material 1506 passes into the solvent reservoir 1586 (e.g., via rotation of one or more rollers 1590), the solvent 1588 can cover the curable material 1506 and thereby isolate the curable material from ambient air. The solvent 1588 can also fill the recesses 1542 within curable material 1506. While covered by the solvent 1588, the curable material 1506 can be circulated into contact with a blade 1592. The blade 1592 can be configured to smooth out the curable material 1506 to remove the recesses 1542 while the curable material 1506 is covered by the solvent 1588. Accordingly, any bubbles introduced into the curable material 1506 by the smoothing process can be composed of the solvent 1588 rather than of air, and thus may automatically rise to the surface of the curable material 1506 and burst rather than remaining within the curable material 1506. Subsequently, the smoothed curable material 1506 can be conveyed out of the solvent reservoir 1586 and toward the material source 1516 for deposition of additional curable material 1506. The solvent 1588 can be separated from the curable material 1506 before the curable material 1506 reaches the material source 1516, e.g., via gravity, evaporation, and/or by a blade 1594 that scrapes the solvent 1588 off the surface of the curable material 1506.

Although FIG. 15 illustrates a system 1500 including a single solvent reservoir 1586, the system 1500 can include any suitable number of solvent reservoirs 1586, which may contain the same or different solvents 1588. Moreover, although the solvent reservoir 1586 is depicted as being located in the deposition zone 1518, the solvent reservoir 1586 can alternatively or additionally be positioned at other locations, such as the post-print zone 1540. Optionally, the system 1500 can include other mechanisms for removing and/or preventing bubbles, such as one or more heating elements, an elongated shaft, a vacuum, etc.

FIG. 16 is a flow diagram illustrating a method 1600 for bubble prevention and/or removal during an additive manufacturing process, in accordance with embodiments of the present technology. The method 1600 can be used to remove one or more recesses (e.g., imprints) in a curable material while the curable material is isolated from ambient air, thereby reducing or eliminating bubbles present in an additively manufactured object fabricated from the curable material (e.g., a dental appliance). The method 1600 can be performed using any of the systems and devices described herein, such as the embodiment of FIG. 15. In some embodiments, some or all of the processes of the method 1600 are implemented as computer-readable instructions (e.g., program code) that are configured to be executed by one or more processors of a computing device, such as a controller of an additive manufacturing system (e.g., a controller of the system 1500 of FIG. 14). The method 1600 can be combined with any of the methods described herein, such as the method 1100 of FIG. 11 and/or the method 1400 of FIG. 14.

The method 1600 can begin at block 1602 with depositing a curable material on a substrate. In some embodiments, the curable material is or includes a photopolymerizable resin. The curable material can be deposited on the substrate from a material source, e.g., such as a nozzle coupled to a reservoir of the curable material. Optionally, the deposited curable material can be smoothed into a thin, uniform material layer on the substrate using one or more blades, with the thickness of the material layer corresponding to the thickness of an object portion to be formed. The substrate can be any structure suitable for supporting the deposited curable material, such as a film, plate, etc. In some embodiments, the substrate is a movable substrate that circulates the curable material toward an energy source for curing, such as a carrier film, movable plate, etc. Alternatively, the substrate can be a stationary substrate having a fixed position and orientation.

At block 1604, the method 1600 can include outputting energy toward the curable material on the substrate to form an object portion on a build platform according to an additive manufacturing process. For example, an energy source (e.g., a laser, projector, light engine) can output energy to at least partially cure the curable material to form the object portion. The energy can be patterned or scanned onto the curable material in a geometry corresponding to the desired geometry for the object portion. In some embodiments, the energy source directs energy through the substrate to reach the curable material, and the substrate is partially or fully transparent to the wavelength of energy produced by the energy source.

At block 1606, the method 1600 can continue with separating the object portion from residual curable material on the substrate. The separation can be performed by moving the build platform away from the residual curable material and substrate, by moving the residual curable material and substrate away from the build platform, or both. The object portion can adhere to the build platform, while the residual curable material remains adhered to the substrate. After the separation, the residual curable can include a recess formed therein corresponding to the separated object portion. The recess may be prone to trapping air or other gases leading to bubble formation, as discussed herein.

At block 1608, the method 1600 can include covering the residual curable material including the recess with a solvent. The solvent can be a fluid or gel that is incompatible with (e.g., immiscible with) the curable material. Examples of materials that may be used for the solvent include silicone-based materials (e.g., polydimethylsiloxane, silicone oil), ionic liquids, polyether or dialkyl ethers, hydrocarbon (e.g., hydrogenated polybutadiene), materials with low viscosity and low vapor pressure, etc. In some embodiments, the solvent is contained within a solvent reservoir, and the substrate with the curable material is conveyed through the solvent reservoir so that the curable material and recess are immersed in the solvent.

At block 1610, the method 1600 can include smoothing out the residual curable material to remove the recess while the residual curable material is covered by the solvent. The smoothing can be performed by a blade that is positioned within the solvent reservoir, for example. The presence of the solvent can isolate the curable material from ambient air during the smoothing process, such that any bubbles that are formed during the smoothing process are composed of the solvent rather than of air. Due to the incompatibility of the curable material and solvent, any solvent bubbles in the curable material can automatically rise to the surface of the curable material and burst.

Subsequently, the method 1600 can return to block 1602 to deposit additional curable material on the substrate in preparation for forming the next portion of the object. Because the recess has been removed from the residual curable material, the deposition of the additional curable material may produce few or no bubbles in the curable material. In some embodiments, after deposition, the curable material includes no more than 100 bubbles/mL, 50 bubbles/mL, 25 bubbles/mL, 10 bubbles/mL, or 5 bubbles/mL. In some embodiments, the processes of the method 1600 eliminate most or all of the bubbles in the curable material having a diameter greater than or equal to 1 mm, 500 μm, 250 μm, 100 μm, 75 μm, 50 μm, 25 μm, or 10 μm. The processes of blocks 1602-1610 can thus be repeated multiple times to build up the object geometry in a layer-by-layer manner, until the entire object geometry has been produced.

The method 1600 illustrated in FIG. 16 can be modified in many different ways. For example, although the above processes of the method 1600 are described with respect to a single object, the method 1600 can be used to sequentially or concurrently fabricate any suitable number of objects, such as tens, hundreds, or thousands of additively manufactured objects. As another example, the ordering of the processes shown in FIG. 16 can be varied, and/or some of the processes of the method 1600 can be omitted. Additionally, the method 1600 can include processes not shown in FIG. 16, such as other techniques for removing bubbles from the curable material (e.g., as previously discussed in connection with FIGS. 6-14), heating of the curable material to a printing temperature, etc. For instance, the method 1600 can include applying a vacuum to the curable material to facilitate bubble removal, alternatively or in addition to removing recesses while the curable material is covered by a solvent.

Although certain embodiments of the additive manufacturing systems and methods herein are described in connection with a carrier film for supporting a curable material, this is not intended to be limiting, and the present technology can be applied to additive manufacturing systems and methods that use other types of substrates to support the curable material. A representative example of another additive manufacturing system that can be used with the techniques herein is described in U.S. Pat. No. 11,426,926, the disclosure of which is incorporated by reference herein in its entirety.

### IV. Dental Appliances and Associated Methods

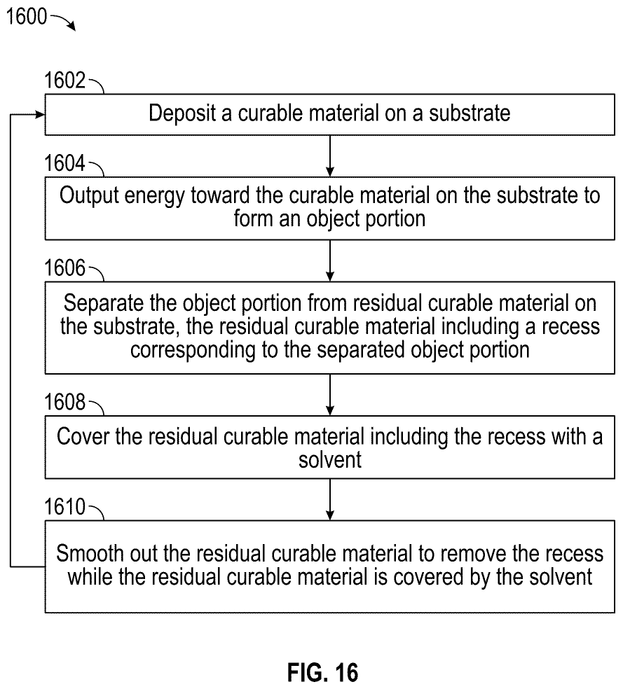

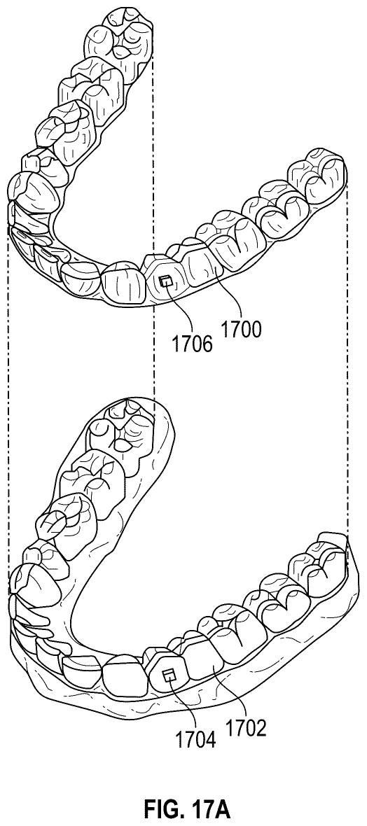

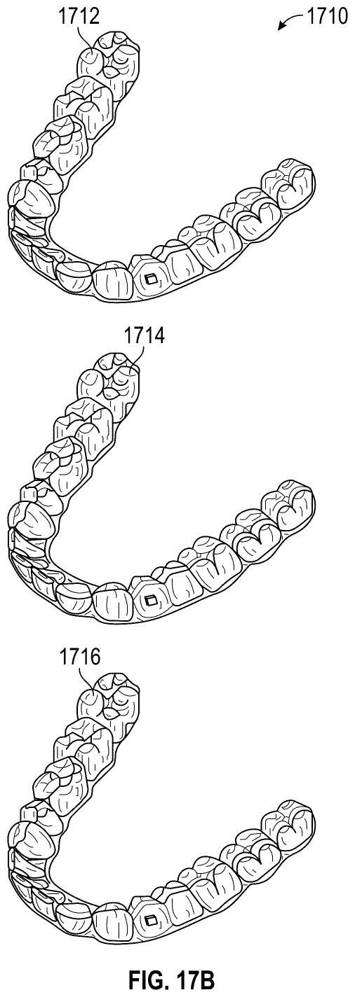

FIG. 17A illustrates a representative example of a tooth repositioning appliance 1700 configured in accordance with embodiments of the present technology. The appliance 1700 can be manufactured using any of the systems, methods, and devices described herein. The appliance 1700 (also referred to herein as an “aligner”) can be worn by a patient in order to achieve an incremental repositioning of individual teeth 1702 in the jaw. The appliance 1700 can include a shell (e.g., a continuous polymeric shell or a segmented shell) having teeth-receiving cavities that receive and resiliently reposition the teeth. The appliance 1700 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1700 can fit over all teeth present in an upper or lower jaw, or less than all of the teeth. The appliance 1700 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1700 can be a generic appliance configured to receive the teeth, but not necessarily shaped to match the topography of the patient's teeth. In some cases, only certain teeth received by the appliance 1700 are repositioned by the appliance 1700 while other teeth can provide a base or anchor region for holding the appliance 1700 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1700 in place over the teeth. In some cases, however, it may be desirable or necessary to provide individual attachments 1704 or other anchoring elements on teeth 1702 with corresponding receptacles 1706 or apertures in the appliance 1700 so that the appliance 1700 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 17B illustrates a tooth repositioning system 1710 including a plurality of appliances 1712, 1714, 1716, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1710 can include a first appliance 1712 corresponding to an initial tooth arrangement, one or more intermediate appliances 1714 corresponding to one or more intermediate arrangements, and a final appliance 1716 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 17C illustrates a method 1720 of orthodontic treatment using a plurality of appliances, in accordance with embodiments of the present technology. The method 1720 can be practiced using any of the appliances or appliance sets described herein. In block 1722, a first orthodontic appliance is applied to a patient's teeth in order to reposition the teeth from a first tooth arrangement to a second tooth arrangement. In block 1724, a second orthodontic appliance is applied to the patient's teeth in order to reposition the teeth from the second tooth arrangement to a third tooth arrangement. The method 1720 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

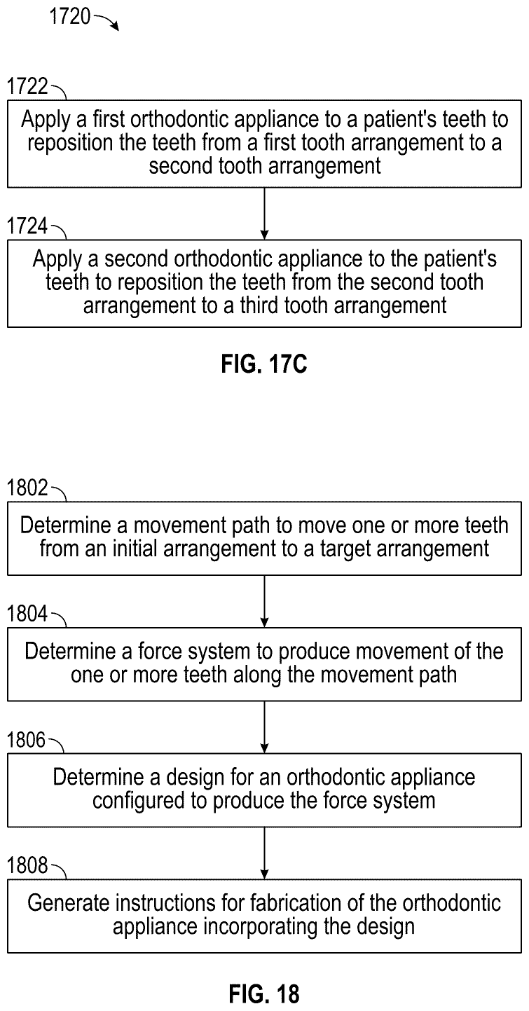

FIG. 18 illustrates a method 1800 for designing an orthodontic appliance, in accordance with embodiments of the present technology. The method 1800 can be applied to any embodiment of the orthodontic appliances described herein. Some or all of the steps of the method 1800 can be performed by any suitable data processing system or device, e.g., one or more processors configured with suitable instructions.

In block 1802, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1804, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1804 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1806, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1808, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1800 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1800 may be performed with any suitable fabrication system or device, such as the embodiments described herein. Some of the steps may be optional, e.g., the process of block 1804 can be omitted, such that the orthodontic appliance is designed based on the desired tooth movements and/or determined tooth movement path, rather than based on a force system. Moreover, the order of the steps can be varied as desired.

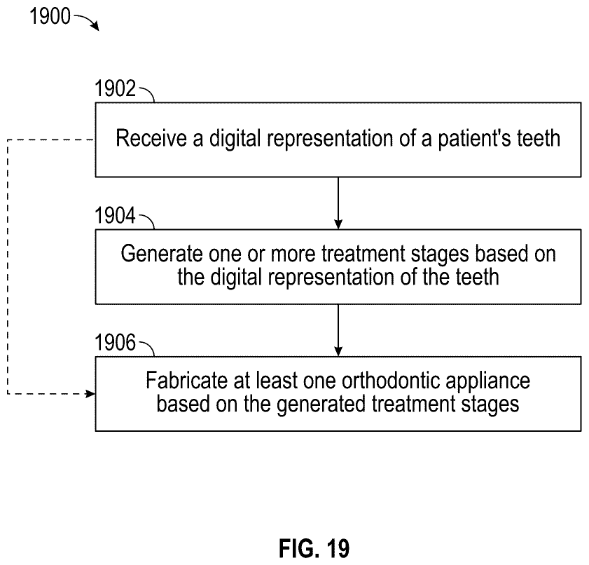

FIG. 19 illustrates a method 1900 for digitally planning an orthodontic treatment and/or design or fabrication of an appliance, in accordance with embodiments. The method 1900 can be applied to any of the treatment procedures described herein and can be performed by any suitable data processing system.

In block 1902, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1904, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1906, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 19, design and/or fabrication of an orthodontic appliance, and perhaps a particular orthodontic treatment, may include use of a representation of the patient's teeth (e.g., including receiving a digital representation of the patient's teeth (block 1902)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement templates, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The present technology is further illustrated by the following non-limiting examples.

### Example 1: Bubble Removal Via Heating

This example describes removal of bubbles from a resin using heated air.

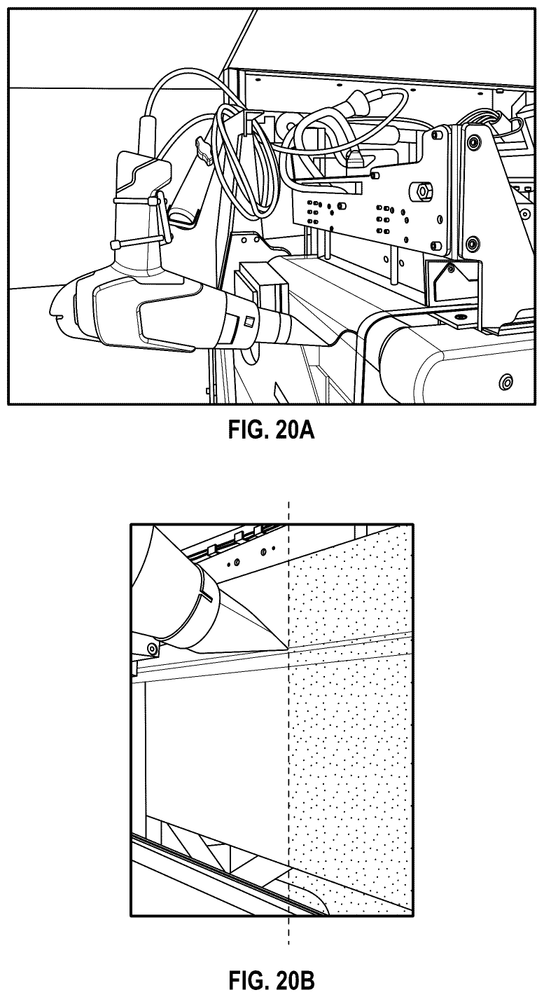

FIGS. 20A and 20B illustrate an additive manufacturing system with a heat gun for removing bubbles, in accordance with embodiments of the present technology. As shown in FIG. 20A, a heat gun was mounted to a Cerion® 3D printing system (Cubicure GmbH) after the coater blade. The heat gun was set to blow 100° C. hot air directly at a portion of the coated resin film. As shown in FIG. 20B, no bubbles were present in the portion of the resin exposed to the hot air (denoted by broken lines in FIG. 20B), whereas numerous bubbles were present in the resin that was not exposed to the hot air.

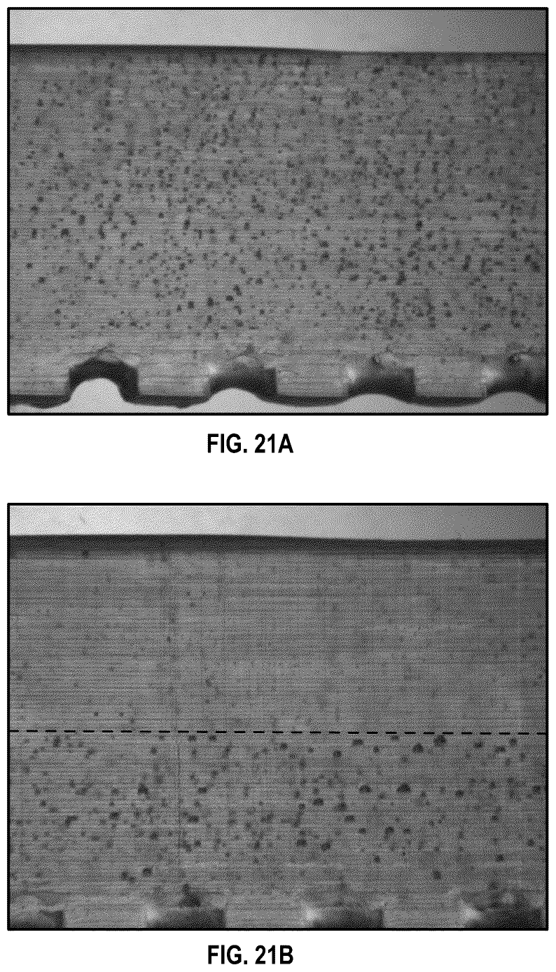

FIGS. 21A and 21B are photographs illustrating a side view of printed object layers before (FIG. 21A) and after (FIG. 21B) application of hot air, in accordance with embodiments of the present technology. As shown in FIG. 21A, the object layers formed before heat was applied to the resin contained numerous bubbles. As shown in FIG. 21B, object layers formed after heat was applied to the resin (denoted by broken lines in FIG. 21B) included no bubbles.

These results demonstrate that heating can be used to successfully remove air bubbles trapped in resin.

### Example 2: Bubble Prevention Via Direct Material Feeding

This example describes prevention of bubble formation by directly feeding resin into the deposition zone.

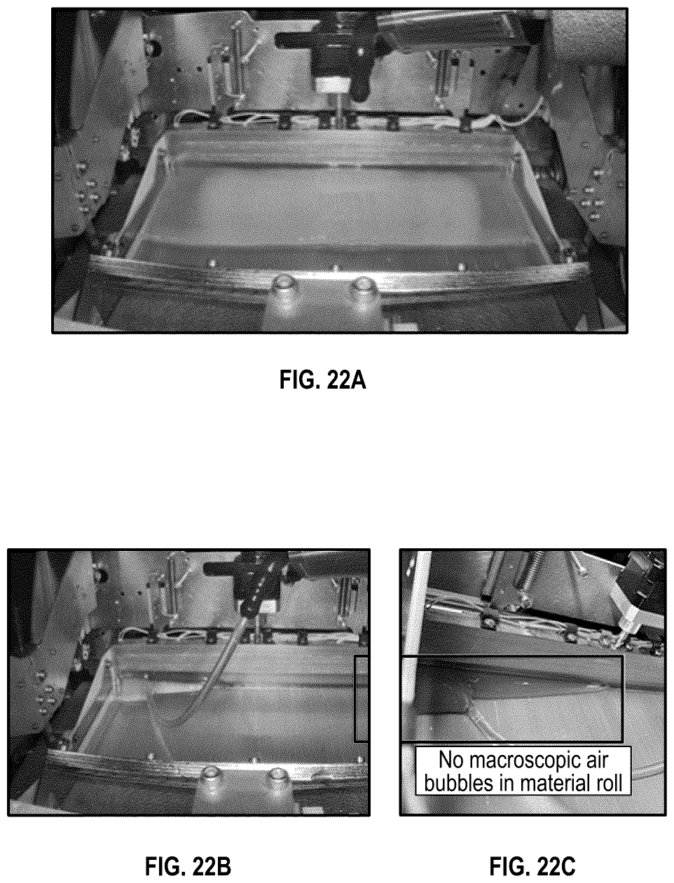

FIGS. 22A-22C are photographs illustrating a deposition zone of an additive manufacturing system with and without direct material feeding to prevent bubble formation, in accordance with embodiments of the present technology. FIG. 22A illustrates a Cerion® 3D printing system without direct material feeding. Specifically, a nozzle was used to drip resin into the deposition zone, resulting in macroscopically observable air bubbles. FIGS. 22B and 22C illustrate a Cerion® 3D printing system in which the nozzle was elongated with tubing to dispense resin directly into the accumulated material (“material roll”) behind the coating blade, resulting in no macroscopically observable air bubbles.

These results demonstrate that direct material feeding can be used to successfully avoid formation of air bubbles in resin.

### ADDITIONAL EXAMPLES

The following examples are included to further describe some aspects of the present technology, and should not be used to limit the scope of the technology.

Clause 1. A system for manufacturing objects, the system comprising:
a material source configured to deposit a curable material on a substrate;
a heating element configured to heat at least a portion of the curable material to remove one or more bubbles present in the curable material; and
an energy source configured to output energy toward the curable material on the substrate to form an object portion according to an additive manufacturing process.

Clause 2. The system of Clause 1, wherein the substrate is a carrier film configured to transport the curable material away from the material source and toward the energy source.

Clause 3. The system of Clause 2, wherein the heating element is positioned proximate to the carrier film downstream of the material source and upstream of the energy source.

Clause 4. The system of Clause 2 or 3, wherein the carrier film comprises a first surface configured to support the curable material and a second surface opposite the first surface, and wherein the heating element is closer in proximity to the first surface than the second surface.

Clause 5. The system of Clause 4, further comprising a cooling element, wherein the cooling element is closer in proximity to the second surface than the first surface.

Clause 6. The system of Clause 5, wherein the heating element and the cooling element are configured to generate a temperature gradient in the curable material.

Clause 7. The system of any one of Clauses 2 to 6, wherein the heating element does not directly contact the carrier film.

Clause 8. The system of any one of Clauses 2 to 7, wherein the object portion is formed on a build platform, and wherein the carrier film is configured to transport residual curable material away from the build platform, the residual curable material comprising a recess corresponding to the formed object portion after the formed object portion is separated from the curable material.

Clause 9. The system of Clause 8, wherein the one or more bubbles are formed during deposition of additional curable material into the recess.

Clause 10. The system of any one of Clauses 1 to 9, wherein the material source is configured to deposit the curable material into accumulated curable material that is already present on the substrate.

Clause 11. The system of Clause 10, wherein the accumulated curable material comprises curable material that has built up behind a blade.

Clause 12. The system of Clause 10, wherein the accumulated curable material comprises curable material within a reservoir.

Clause 13. The system of any one of Clauses 1 to 12, further comprising a blade configured to form a material layer of the curable material on the substrate.

Clause 14. The system of Clause 13, wherein the heating element is configured to output heat toward the material layer.

Clause 15. The system of any one of Clauses 1 to 14, wherein the heating element is configured to heat only a surface of the curable material.

Clause 16. The system of any one of Clauses 1 to 14, wherein the heating element is configured to output heat toward the material source.

Clause 17. The system of any one of Clauses 1 to 16, wherein the heating element is configured to heat the at least a portion of the curable material to a temperature greater than 40° C., 50° C., or 60° C.

Clause 18. The system of any one of Clauses 1 to 17, wherein the heating element is configured to decrease a viscosity of the curable material, decrease a surface tension of the curable material, or increase a motility of the one or more bubbles in the curable material, or a combination thereof.

Clause 19. The system of any one of Clauses 1 to 18, wherein the effect of thermophoresis is used to enhance movement of one or more bubbles in the curable material toward a hotter area of the curable material.

Clause 20. The system of any one of Clauses 1 to 19, wherein the heating element is configured to cause the one or more bubbles to rise toward a surface of the curable material.

Clause 21. The system of any one of Clauses 1 to 20, wherein the heating element is configured to output a stream of heated fluid.

Clause 22. The system of Clause 21, wherein the heated fluid is a heated gas.

Clause 23. The system of Clause 21 or 22, wherein the stream of heated fluid is output at a flow rate within a range from 1 m/s to 50 m/s, 3 m/s to 40 m/s, or 4 m/s to 35 m/s.

Clause 24. The system of any one of Clauses 1 to 23, wherein the heating element comprises a radiation emitter.

Clause 25. The system of any one of Clauses 1 to 24, wherein the heating element comprises a laser emitter.

Clause 26. The system of any one of Clauses 1 to 25, further comprising a cover at least partially enclosing the material source and extending over a portion of the substrate, wherein the heating element is configured to heat an environment within the cover.

Clause 27. The system of any one of Clauses 1 to 26, further comprising a blade configured to form the curable material into a material layer after deposition on the substrate, wherein the heating element is configured to heat the blade.

Clause 28. The system of any one of Clauses 1 to 27, wherein the heating element is configured to heat the curable material without curing the curable material.

Clause 29. The system of any one of Clauses 1 to 28, wherein the energy source is configured to output light energy to cure at least a portion of the curable material on the substrate to form the object portion.

Clause 30. The system of any one of Clauses 1 to 29, wherein the curable material comprises a polymerizable resin.

Clause 31. The system of any one of Clauses 1 to 30, wherein the curable material has a viscosity in the range of 0.05 Pa·s to 100 Pa·s at a temperature within a range from 20° C. to 160° C., 40° C. to 140° C., or 50° C. to 120° C.

Clause 32. The system of any one of Clauses 1 to 31, further comprising a second heating element configured to heat the curable material to a printing temperature, wherein the second heating element is different from the first heating element.

Clause 33. The system of any one of Clauses 1 to 32, wherein the object portion is a portion of a dental appliance.

Clause 34. A method comprising:
depositing a curable material on a substrate;
directing heat toward the curable material to remove one or more bubbles present in the curable material; and
outputting energy toward the curable material on the substrate to form an object portion on a build platform according to an additive manufacturing process.

Clause 35. The method of Clause 34, wherein the substrate is a carrier film configured to transport the curable material proximate to the build platform.

Clause 36. The method of Clause 35, wherein the curable material is deposited from a material source, and wherein the heat is output by a heating element positioned proximate to the carrier film downstream of the material source and upstream of the build platform.

Clause 37. The method of Clause 36, wherein the carrier film comprises a first surface configured to support the curable material and a second surface opposite the first surface, and wherein the heating element is closer to the first surface than the second surface.

Clause 38. The method of Clause 37, further comprising cooling at least a portion of the curable material.

Clause 39. The method of Clause 38, wherein the directed heat and the cooling are configured to generate a temperature gradient in the curable material.

Clause 40. The method of any one of Clauses 34 to 39, wherein the heat does not directly heat the carrier film.

Clause 41. The method of any one of Clauses 34 to 40, further comprising transporting residual curable material away from the build platform, the residual curable material comprising a recess corresponding to the formed object portion after the formed object portion is separated from the curable material.

Clause 42. The method of Clause 41, wherein the one or more bubbles are formed during deposition of additional curable material into the recess.

Clause 43. The method of any one of Clauses 34 to 43, wherein the curable material is deposited into accumulated curable material that is already present on the substrate.

Clause 44. The method of Clause 43, wherein the accumulated curable material comprises curable material that has built up behind a blade.

Clause 45. The method of Clause 43, wherein the accumulated curable material comprises curable material within a reservoir.

Clause 46. The method of any one of Clauses 34 to 45, wherein the curable material is formed into a material layer on the substrate.

Clause 47. The method of Clause 46, wherein the heat is directed toward the material layer.

Clause 48. The method of any one of Clauses 34 to 47, wherein the heat only heats a surface of the curable material.

Clause 49. The method of any one of Clauses 34 to 48, wherein the curable material is deposited from a material source, and wherein directing the heat toward the curable material comprises heating the material source.

Clause 50. The method of any one of Clauses 34 to 49, wherein at least a portion of the curable material is heated to a temperature greater than 40° C., 50° C., or 60° C.

Clause 51. The method of any one of Clauses 34 to 50, wherein the heat decreases a viscosity of the curable material, decreases a surface tension of the curable material, increases a motility of the one or more bubbles in the curable material, or a combination thereof.

Clause 52. The method of any one of Clauses 34 to 51, wherein the effect of thermophoresis is used to enhance movement of one or more bubbles in the curable material toward a hotter area of the curable material.

Clause 53. The method of any one of Clauses 34 to 52, wherein the heat causes the one or more bubbles to rise toward a surface of the curable material.

Clause 54. The method of any one of Clauses 34 to 53, wherein directing the heat toward the curable material comprises outputting a stream of heated fluid toward the curable material.

Clause 55. The method of Clause 54, wherein the heated fluid is a heated gas.

Clause 56. The method of Clause 54 or 55, wherein the stream of heated fluid is output at a flow rate within a range from 1 m/s to 50 m/s, 3 m/s to 40 m/s, or 4 m/s to 35 m/s.

Clause 57. The method of any one of Clauses 34 to 56, wherein directing the heat toward the curable material comprises emitting radiation toward the curable material.

Clause 58. The method of any one of Clauses 34 to 57, wherein directing the heat toward the curable material comprises directing a laser beam onto the curable material.

Clause 59. The method of any one of Clauses 34 to 58, wherein the curable material is deposited from a material source, and wherein directing the heat toward the curable material comprises heating an environment within a cover extending over the material source and a portion of the substrate.

Clause 60. The method of any one of Clauses 34 to 59, wherein directing the heat toward the curable material comprises heating a blade configured to form the curable material into a material layer after deposition on the substrate.

Clause 61. The method of any one of Clauses 34 to 60, wherein the heat does not cure the curable material.

Clause 62. The method of any one of Clauses 34 to 61, wherein the energy comprises light energy, and wherein the light energy is configured to cure at least a portion of the curable material on the substrate to form the object portion.

Clause 63. The method of any one of Clauses 34 to 62, wherein the curable material comprises a polymerizable resin.

Clause 64. The method of any one of Clauses 34 to 63, wherein the curable material has a viscosity in the range of 0.05 Pa·s to 100 Pa·s at a temperature within a range from 20° C. to 160° C., 40° C. to 140° C., or 50° C. to 120° C.

Clause 65. The method of any one of Clauses 34 to 64, further comprising heating the curable material to a printing temperature.

Clause 66. The method of any one of Clauses 34 to 65, wherein the object portion is a portion of a dental appliance.

Clause 67. A system for manufacturing objects, the system comprising:
a material source configured to deposit a curable material on a carrier film;
an energy source configured to output energy toward the curable material on the carrier film to form an object portion on a build platform according to an additive manufacturing process;
an actuator configured to cause movement of the carrier film relative to the build platform to separate the object portion from residual curable material on the carrier film, wherein the separation leaves a recess in the residual curable material; and
an elongated shaft positioned against the substrate,
wherein the carrier film is movable relative to the elongated shaft to cause the residual curable material to be displaced from the carrier film and flow over the elongated shaft, thereby eliminating the recess.

Clause 68. The system of Clause 67, wherein the carrier film is configured to transport the curable material proximate to the build platform.

Clause 69. The system of Clause 67 or 68, wherein the material source is configured to deposit a material layer of the curable material on the carrier film.

Clause 70. The system of any one of Clauses 67 to 69, wherein the elongated shaft is positioned downstream of the energy source and upstream of the material source.

Clause 71. The system of any one of Clauses 67 to 70, wherein the elongated shaft is cylindrical.

Clause 72. The system of any one of Clauses 67 to 71, wherein the elongated shaft comprises a wire.

Clause 73. The system of any one of Clauses 67 to 72, wherein the elongated shaft comprises a thin plate.

Clause 74. The system of any one of Clauses 67 to 73, wherein the elongated shaft extends across a width of the carrier film.

Clause 75. The system of any one of Clauses 67 to 74, wherein the elongated shaft is stationary relative to the carrier film.

Clause 76. The system of any one of Clauses 67 to 75, wherein the elongated shaft is configured to rotate about a longitudinal axis of the elongated shaft.

Clause 77. The system of any one of Clauses 67 to 76, wherein the elongated shaft comprises a coated surface configured to prevent adhesion of the curable material.

Clause 78. The system of any one of Clauses 67 to 77, further comprising a heating element configured to heat the elongated shaft.

Clause 79. The system of any one of Clauses 67 to 78, wherein the material source is configured to deposit additional curable material onto the residual curable material after the recess is eliminated.

Clause 80. The system of any one of Clauses 67 to 79, wherein the material source is configured to deposit the curable material into accumulated curable material that is already present on the substrate.

Clause 81. The system of Clause 80, wherein the accumulated curable material comprises curable material that has built up behind a blade.

Clause 82. The system of Clause 80, wherein the accumulated material comprises curable material without a reservoir.

Clause 83. The system of any one of Clauses 67 to 82, wherein the curable material comprises a polymerizable resin.

Clause 84. The system of any one of Clauses 67 to 83, wherein the curable material has a viscosity in the range of 0.05 Pa·s to 100 Pa·s at a temperature within a range from 20° C. to 160° C., 40° C. to 140° C., or 50° C. to 120° C.

Clause 85. The system of any one of Clauses 67 to 84, wherein the object portion is a portion of a dental appliance.

Clause 86. A method comprising:
depositing a curable material on a carrier film;
outputting energy toward the curable material on the carrier film to form an object portion on a build platform according to an additive manufacturing process;
separating the object portion from residual curable material on the carrier film, wherein after the separation, the residual curable material includes a recess corresponding to the separated object portion; and
displacing the residual curable material from the carrier film using an elongated shaft positioned against the carrier film, wherein the displaced residual curable material flows over the elongated shaft, thereby eliminating the recess.

Clause 87. The method of Clause 86, wherein the carrier film is configured to transport the curable material proximate to a build platform.

Clause 88. The method of Clause 86 or 87, wherein the curable material is deposited as a material layer on the carrier film.

Clause 89. The method of any one of Clauses 86 to 88, wherein the curable material is deposited by a material source, the energy is outputted from an energy source, and wherein the elongated shaft is positioned downstream of the energy source and upstream of the material source.

Clause 90. The method of any one of Clauses 86 to 89, wherein the elongated shaft is cylindrical.

Clause 91. The method of any one of Clauses 86 to 90, wherein the elongated shaft comprises a wire.

Clause 92. The method of any one of Clauses 86 to 91, wherein the elongated shaft comprises a thin plate.

Clause 93. The method of any one of Clauses 86 to 92, wherein the elongated shaft extends across a width of the carrier film.

Clause 94. The method of any one of Clauses 86 to 93, wherein the elongated shaft is stationary relative to the carrier film.

Clause 95. The method of any one of Clauses 86 to 94, wherein the elongated shaft is configured to rotate about a longitudinal axis of the elongated shaft.

Clause 96. The method of any one of Clauses 86 to 95, wherein the elongated shaft comprises a coated surface configured to prevent adhesion of the curable material.

Clause 97. The method of any one of Clauses 86 to 96, further comprising heating the elongated shaft.

Clause 98. The method of any one of Clauses 86 to 97, further comprising depositing additional curable material onto the residual curable material after the recess is eliminated.

Clause 99. The method of any one of Clauses 86 to 98, wherein the curable material is deposited into accumulated curable material that is already present on the substrate.

Clause 100. The method of Clause 99, wherein the accumulated curable material comprises curable material that has built up behind a blade.

Clause 101. The method of Clause 99, wherein the accumulated material comprises curable material without a reservoir.

Clause 102. The method of any one of Clauses 86 to 101, wherein the curable material comprises a polymerizable resin.

Clause 103. The method of any one of Clauses 86 to 102, wherein the curable material has a viscosity in the range of 0.05 Pa·s to 100 Pa·s at a temperature within a range from 20° C. to 160° C.

Clause 104. The method of any one of Clauses 86 to 103, wherein the object portion is a portion of a dental appliance.

Clause 105. A system for manufacturing objects, the system comprising:
a material source configured to deposit a curable material on a substrate;
an energy source configured to output energy toward the curable material on the substrate to form an object portion on a build platform according to an additive manufacturing process;
a solvent reservoir configured to cover residual curable material left on the substrate after the object portion has been separated from the substrate with a solvent, wherein the residual curable material includes a recess corresponding to the separated object portion; and
a blade disposed in the solvent reservoir, the blade configured to smooth out the residual curable material to remove the recess while the residual curable material is covered by the solvent.

Clause 106. The system of Clause 105, wherein the substrate is a carrier film configured to transport the curable material proximate to the build platform.

Clause 107. The system of Clause 105 or 106, wherein the material source is configured to deposit a material layer of the curable material on the substrate.

Clause 108. The system of any one of Clauses 105 to 107, wherein the material source is configured to deposit the curable material into accumulated curable material that is already present on the substrate.

Clause 109. The system of Clause 108, wherein the accumulated curable material comprises curable material that has built up behind a blade.

Clause 110. The system of Clause 108, wherein the accumulated material comprises curable material without a reservoir.

Clause 111. The system of any one of Clauses 105 to 110, wherein the solvent reservoir is positioned downstream of the material source and upstream of the energy source, and wherein the substrate is configured to pass through the solvent reservoir.

Clause 112. The system of any one of Clauses 105 to 111, wherein the solvent comprises a fluid that is incompatible with the residual curable material.

Clause 113. The system of Clause 112, wherein the solvent is configured to temporarily fill the recess with the fluid.

Clause 114. The system of Clause 112 or 113, wherein smoothing out the residual curable material comprises applying force to the residual curable material to displace the fluid.

Clause 115. The system of any one of Clauses 112 to 114, wherein the fluid has a vapor pressure less than 0.1 mmHg at 70° C.

Clause 116. The system of any one of Clauses 112 to 115, wherein the fluid comprises a silicone-based material, an ionic liquid, a polyether, a dialkyl ether, or a hydrocarbon.

Clause 117. The system of any one of Clauses 112 to 116, wherein the fluid comprises a gel.

Clause 118. The system of any one of Clauses 112 to 117, wherein the fluid is configured to isolate the residual curable material from air.

Clause 119. The system of any one of Clauses 105 to 118, wherein the blade is stationary relative to the substrate.

Clause 120. The system of any one of Clauses 105 to 119, wherein the blade comprises a coated surface configured to prevent adhesion of the curable material.

Clause 121. The system of any one of Clauses 105 to 120, further comprising a heating element configured to heat the blade.

Clause 122. The system of any one of Clauses 105 to 121, wherein the curable material comprises a polymerizable resin.

Clause 123. The system of any one of Clauses 105 to 122, wherein the curable material has a viscosity in the range of 0.05 Pa·s to 100 Pa·s at a temperature within a range from 20° C. to 160° C., 40° C. to 140° C., or 50° C. to 120° C.

Clause 124. The system of any one of Clauses 105 to 123, wherein the object portion is a portion of a dental appliance.

Clause 125. A method comprising:
depositing a curable material on a substrate;
outputting energy toward the curable material on the substrate to form an object portion on a build platform according to an additive manufacturing process;
separating the object portion from residual curable material, wherein after the separation, the residual curable material includes a recess corresponding to the separated object portion;
covering the residual curable material including the recess with a solvent; and
smoothing out the residual curable material to remove the recess from the residual curable material while the residual curable material is covered by the solvent.

Clause 126. The method of Clause 125, wherein the substrate is a carrier film configured to transport the curable material proximate to the build platform.

Clause 127. The method of Clause 125 or 126, wherein the curable material is deposited as a material layer on the substrate.

Clause 128. The method of any one of Clauses 125 to 127, wherein the curable material is deposited into accumulated curable material that is already present on the substrate.

Clause 129. The method of Clause 128, wherein the accumulated curable material comprises curable material that has built up behind a blade.

Clause 130. The method of Clause 128, wherein the accumulated curable material comprises curable material within a reservoir.

Clause 131. The method of any one of Clauses 125 to 130, wherein the curable material is deposited from a material source, the energy is outputted from an energy source, the solvent is sourced from a solvent reservoir, and wherein the solvent reservoir is positioned downstream of the material source and upstream of the energy source, and wherein the substrate is configured to pass through the solvent reservoir.

Clause 132. The method of any one of Clauses 125 to 131, wherein the solvent comprises a fluid that is incompatible with the residual curable material.

Clause 133. The method of Clause 132, wherein the solvent is configured to temporarily fill the recess with the fluid.

Clause 134. The method of Clause 132 or 133, wherein smoothing out the residual curable material comprises applying force to the residual curable material to displace the fluid.

Clause 135. The method of any one of Clauses 132 to 134, wherein the fluid has a vapor pressure less than 0.01 mmHg at 70° C.

Clause 136. The method of any one of Clauses 132 to 135, wherein the fluid comprises a silicone-based material, an ionic liquid, a polyether, a dialkyl ether, or a hydrocarbon.

Clause 137. The method of any one of Clauses 132 to 136, wherein the fluid is configured to isolate the residual curable material from air.

Clause 138. The method of any one of Clauses 125 to 137, wherein smoothing out the residual curable material comprises contacting the residual curable material with a blade, and wherein the blade is stationary relative to the substrate.

Clause 139. The method of Clause 138, further comprising heating the blade.

Clause 140. The method of any one of Clauses 125 to 139, wherein the curable material comprises a polymerizable resin.

Clause 141. The method of any one of Clauses 125 to 140, wherein the curable material has a viscosity in the range of 0.05 Pa·s to 100 Pa·s at a temperature within a range from 20° C. to 160° C., 40° C. to 140° C., or 50° C. to 120° C.

Clause 142. The method of any one of Clauses 125 to 141, wherein the object portion is a portion of a dental appliance.

Clause 143. A system for manufacturing objects, the system comprising:
a substrate configured to carry a curable material;
a blade positioned proximate to the substrate, wherein the blade is configured to create a flow restriction that causes the curable material to accumulate behind the blade;
a material source configured to deposit additional curable material directly into the accumulated curable material behind the blade; and
an energy source configured to output energy toward the curable material on the substrate to form an object portion according to an additive manufacturing process.

Clause 144. The system of Clause 143, wherein the material source comprises an elongate tube including a first end coupled to a reservoir of the curable material and a second end inserted into the accumulated curable material.

Clause 145. The system of Clause 144, wherein the curable material in the reservoir is at a first temperature and the accumulated curable material is at a second temperature that is higher than the first temperature.

Clause 146. The system of any one of Clauses 143 to 145, wherein the substrate is a carrier film configured to transport the curable material away from the material source and toward the energy source.

Clause 147. The system of any one of Clauses 143 to 146, further comprising a heating element configured to heat at least a portion of the curable material on the substrate.

Clause 148. The system of any one of Clauses 143 to 147, wherein the energy source is configured to output light energy to cure at least a portion of the curable material on the substrate to form the object portion.

Clause 149. The system of any one of Clauses 143 to 148, wherein the curable material comprises a polymerizable resin.

Clause 150. The system of any one of Clauses 143 to 149, wherein the curable material has a viscosity in the range of 0.05 Pa·s to 100 Pa·s at a temperature within a range from 20° C. to 160° C., 40° C. to 140° C., or 50° C. to 120° C.

Clause 151. The system of any one of Clauses 143 to 150, wherein the object portion is a portion of a dental appliance.

Clause 152. A method comprising:
positioning a blade proximate to a substrate, wherein the blade creates a flow restriction that causes curable material on the substrate to accumulate behind the blade;
depositing additional curable material directly into the accumulated curable material behind the blade; and
outputting energy toward the curable material on the substrate to form an object portion on a build platform according to an additive manufacturing process.

Clause 153. The method of Clause 152, where the additional curable material is deposited by a material source comprising an elongate tube including a first end coupled to a reservoir of the curable material and a second end inserted into the accumulated curable material.

Clause 154. The method of Clause 153, wherein the curable material in the reservoir is at a first temperature and the accumulated curable material is at a second temperature that is higher than the first temperature.

Clause 155. The method of any one of Clauses 152 to 154, wherein the substrate is a carrier film configured to transport the curable material toward the build platform.

Clause 156. The method of any one of Clauses 152 to 155, further comprising directing heat toward at least a portion of the curable material on the substrate.

Clause 157. The method of any one of Clauses 152 to 156, wherein the energy comprises light energy, and wherein the light energy is configured to cure at least a portion of the curable material on the substrate to form the object portion.

Clause 158. The method of any one of Clauses 152 to 157, wherein the curable material comprises a polymerizable resin.

Clause 159. The method of any one of Clauses 152 to 158, wherein the curable material has a viscosity in the range of 0.05 Pa·s to 100 Pa·s at a temperature within a range from 20° C. to 160° C., 40° C. to 140° C., or 50° C. to 120° C.

Clause 160. The method of any one of Clauses 152 to 159, wherein the object portion is a portion of a dental appliance.

### CONCLUSION

Although many of the embodiments are described above with respect to systems, devices, and methods for additive manufacturing of dental appliances, the technology is applicable to other applications and/or other approaches, such as additive manufacturing of other objects, and with a variety of materials (e.g., low viscosity materials). Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-22C.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
depositing a curable material on a substrate;
directing heat toward the curable material to remove one or more bubbles present in the curable material; and
outputting energy toward the curable material on the substrate to form an object portion on a build platform according to an additive manufacturing process.

2. The method of claim 1, wherein the substrate is a carrier film configured to transport the curable material proximate to the build platform.

3. The method of claim 2, wherein the curable material is deposited from a material source, and wherein the heat is output by a heating element positioned proximate to the carrier film downstream of the material source and upstream of the build platform.

4. The method of claim 2, wherein the carrier film comprises a first surface configured to support the curable material and a second surface opposite the first surface, and wherein the heating element is closer to the first surface than the second surface.

5. The method of claim 2, further comprising transporting residual curable material away from the build platform, the residual curable material comprising a recess corresponding to the formed object portion after the formed object portion is separated from the curable material.

6. The method of claim 5, wherein the one or more bubbles are formed during deposition of additional curable material into the recess.

7. The method of claim 1, wherein the curable material is deposited into accumulated curable material that is already present on the substrate.

8. The method of claim 1, wherein the curable material is formed into a material layer on the substrate.

9. The method of claim 8, wherein the heat is directed toward the material layer.

10. The method of claim 1, wherein the curable material is deposited from a material source, and wherein directing the heat toward the curable material comprises heating the material source.

11. The method of claim 1, wherein at least a portion of the curable material is heated to a temperature greater than 40° C., 50° C., or 60° C.

12. The method of claim 1, wherein the heat decreases a viscosity of the curable material, decreases a surface tension of the curable material, increases a motility of the one or more bubbles in the curable material, or a combination thereof.

13. The method of claim 1, wherein directing the heat toward the curable material comprises outputting a stream of heated fluid toward the curable material.

14. The method of claim 13, wherein the heated fluid is a heated gas.

15. The method of claim 1, wherein directing the heat toward the curable material comprises emitting radiation toward the curable material.

16. The method of claim 1, wherein directing the heat toward the curable material comprises heating a blade configured to form the curable material into a material layer after deposition on the substrate.

17. The method of claim 1, wherein the heat does not cure the curable material.

18. The method of claim 1, wherein the curable material comprises a polymerizable resin.

19. The method of claim 1, wherein the curable material has a viscosity in the range of 0.05 Pa·s to 100 Pa·s at a temperature within a range from 20° C. to 160° C., 40° C. to 140° C., or 50° C. to 120° C.

20. The method of claim 1, wherein the object portion is a portion of a dental appliance.
